(19) United States
(12) Patent Application Publication
(10) Pub. No.: US 2025/0317739 A1
(43) Pub. Date: Oct. 9, 2025

(54) DEEP LEARNING-BASED WIRELESS INTRUSION DETECTION

(71) Applicant: Cisco Technology, Inc., San Jose, CA (US)

(72) Inventors: Peiman Amini, Fremont, CA (US); Jerome Henry, Pittsboro, NC (US); Niloo Bahadori, Greensboro, NC (US); Bahador Amiri, Saratoga, CA (US); Ardalan Alizadeh, Campbell, CA (US)

(21) Appl. No.: 19/051,093

(22) Filed: Feb. 11, 2025

Related U.S. Application Data
(60) Provisional application No. 63/574,185, filed on Apr. 3, 2024.

(51) Int. Cl. H04W 12/121; G06N 20/00

(52) U.S. Cl. CPC H04W 12/121; G06N 20/00

(57) ABSTRACT

Systems, devices, and methods for wireless intrusion detection based on deep learning are provided. A network device collects legitimate network traffic over a time period and learns a first set of features that represents the legitimate network traffic. The network device generates synthetic network traffic based on the learned first set of features and trains a machine learning model based on the learned first set of features and the synthetic network traffic. Based on the training, the machine learning model learns a second set of features that differentiates the synthetic network traffic from the legitimate network traffic. The devices and methods precisely detect potential security threats, while reducing false positives, thereby ensuring a sensitive and accurate response to genuine anomalies. Further, the devices and methods improve accuracy of detection of potential security threats including known and new attacks in wireless networks, while adapting to evolving attack techniques and network dynamics.

### CROSS-REFERENCE TO RELATED APPLICATIONS

This application claims the benefit of priority to U.S. Provisional Application No. 63/574,185, filed Apr. 3, 2024, the entirety of which is incorporated herein by reference.

### FIELD

The present disclosure relates to network security and management. More particularly, the present disclosure relates to wireless intrusion detection based on deep learning.

### BACKGROUND

With the exponential growth of digital technologies and increasing dependence on interconnected networks, there is a growing need for robust network security. Most organizations are substantially dependent on their network infrastructure to conduct business, communicate, and store sensitive information. Network security may aim to protect integrity, confidentiality, and availability of data and resources on a network, thereby safeguarding an organization's data, systems, network infrastructure, and resources against threats, for example, malware, system vulnerabilities, or the like, and attacks such as unauthorized access, data breaches, Denial-of-Service (DoS) attacks, ransomware attacks, damage, or the like. Many organizations may require monitoring of network traffic to ensure compliance with security policies and regulations. As network environments increase in size and complexity, a large amount of data is collected and generated in monitoring the network environments. Unfortunately, the large amount of data generated for network environments makes it more difficult to analyze the data and subsequently monitor network environments to determine anomalies in the network environments. Moreover, as states of network environments change after an anomaly occurs, often before an administrator can determine a network state at the time of the anomaly, it can be difficult for administrators to correctly diagnose and fix problems in the network environments.

One of the challenges in securing a network may lie in distinguishing between legitimate traffic, corrupted traffic, and anomalous traffic. Data and requests that are part of regular operations, including user communications, data transfers, and system processes may constitute legitimate traffic. Corrupted traffic may include, for example, packets that have been altered, damaged, or otherwise degraded during transmission, typically due to errors or disruptions in the network. Further, anomalous traffic may include, for example, any traffic that deviates from established patterns, which may indicate malicious activities such as Distributed Denial-of-Service (DDoS) attacks, unauthorized data access, malware infections, or system intrusions among other cyberattacks such as Man-in-the-Middle (MitM) attacks, sniffing attacks, data exfiltration, malware, spoofing attacks, or the like. Early detection of the corrupted traffic may allow the corresponding packets to be discarded or retransmitted, while early detection of the anomalous traffic may allow security teams to execute proactive measures such as blocking malicious sources, adjusting firewall rules, or implementing new security protocols, to prevent attacks from escalating.

Wireless networks, for example, Wi-Fi® networks, may be inherently more vulnerable to attacks than wired networks because they are susceptible to unauthorized access, for example, via eavesdropping or jamming, exploitation of the open nature of radio waves, or the like. Conventional intrusion detection systems may fail to adequately protect these wireless networks against the ever-changing landscape of cyber threats. Some intrusion detection systems may require significant resources to function effectively, impacting overall network performance. Moreover, these intrusion detection systems, which often depend on static rules, known attack patterns, or signature-based detection, may fail to handle new or complex threats or attacks, leading to a high rate of false alarms. This challenge may be exacerbated by the complex and diverse nature of network traffic, for example, Wi-Fi network traffic, making it difficult to accurately identify what constitutes normal behavior versus abnormal or anomalous behavior. Further, these intrusion detection systems may find it difficult to detect new, unknown attacks, for example, zero-day attacks, leaving networks vulnerable to potential security risks. Further, intrusion detection systems can be prone to false positives, especially in systems based on anomaly detection.

### SUMMARY OF THE DISCLOSURE

Systems, devices, and methods for wireless intrusion detection based on deep learning in accordance with embodiments of the disclosure are described herein. In many embodiments, a network device comprises a processor, a network interface controller configured to provide access to a network, and a memory communicatively coupled to the processor for deep learning-based wireless intrusion detection. The memory comprises an anomaly detection logic configured to collect legitimate network traffic over a time period; learn a first set of features that represents the collected legitimate network traffic; generate synthetic network traffic based on the learned first set of features; and train a machine learning model based on the learned first set of features and the generated synthetic network traffic. Based on the training, the machine learning model learns a second set of features that differentiates the generated synthetic network traffic from the collected legitimate network traffic.

In a number of embodiments, the anomaly detection logic is further configured to: receive, within a time window, new network traffic comprising a sequence of packets; and generate, based on the trained machine learning model, a time series of scores for the sequence of packets, wherein each score in the time series of scores corresponds to a packet of the sequence of packets and indicates a likelihood of the packet deviating from being legitimate.

In a variety of embodiments, the anomaly detection logic is further configured to classify the packet as one of legitimate, corrupted, or anomalous based on a corresponding score in the time series of scores.

In various embodiments, the anomaly detection logic is further configured to: aggregate the time series of scores to obtain an aggregate score; compare the aggregate score with a threshold value; and detect an intrusion event within the time window based on a result of the comparison.

In more embodiments, the intrusion event is detected within the time window based on the result indicating that the aggregate score is greater than the threshold value.

In additional embodiments, the intrusion event is detected within the time window based on the result indicating that the aggregate score is less than the threshold value.

In further embodiments, the first set of features comprises one or more of: header characteristics, payload characteristics, temporal characteristics, or state transition characteristics associated with the legitimate network traffic.

In still more embodiments, the learning of the first set of features is based on another machine learning model different from the machine learning model.

In still further embodiments, the generation of the synthetic network traffic is based on another machine learning model, and the machine learning model and the another machine learning model correspond to a generative adversarial network.

In still additional embodiments, during the training of the machine learning model, the anomaly detection logic is further configured to: receive feedback from the machine learning model; and re-generate the synthetic network traffic based on the feedback, wherein the machine learning model is further trained based on the re-generated synthetic network traffic.

In some more embodiments, the generation of the synthetic network traffic comprises generating a plurality of valid packets that mimics the legitimate network traffic.

In yet various embodiments, the generation of the synthetic network traffic comprises generating a plurality of invalid packets including one or more corrupted packets and one or more anomalous packets.

In yet more embodiments, each packet of the plurality of invalid packets is different from the legitimate network traffic in terms of at least one of: a packet structure, one or more protocol specifications, header characteristics, payload characteristics, temporal characteristics, or state transition characteristics.

In still yet more embodiments, the network device corresponds to an edge-based network device.

In many further embodiments, the network device corresponds to one of an access point, a switch, or a router.

In many additional embodiments, the memory of the network device comprises an anomaly detection logic configured to collect legitimate network traffic comprising a plurality of packets; and classify the collected legitimate network traffic into a plurality of categories based on one or more criteria, wherein based on the classification, each category of the plurality of categories comprises a corresponding subset of packets of the plurality of packets. For each category of the plurality of categories, the anomaly detection logic is further configured to learn a first set of features based on the corresponding subset of packets; generate synthetic network traffic based on the learned first set of features; and train a machine learning model based on the learned first set of features and the generated synthetic network traffic, wherein based on the training, the machine learning model learns a second set of features that differentiates the generated synthetic network traffic from the corresponding subset of packets.

In still yet further embodiments, the one or more criteria comprises at least one of a packet type or a connection state.

In still yet additional embodiments, the packet type comprises at least one of: a management frame, a control frame, or a data frame.

In several embodiments, the connection state comprises at least one of: scanning, pre-authentication, authentication, association, or data exchange.

In several more embodiments, the anomaly detection logic is further configured to: receive at least one new packet; identify, from among the plurality of categories, a category associated with the received at least one new packet; and classify the at least one new packet as one of: legitimate, corrupted, or anomalous based on the trained machine learning model corresponding to the identified category.

In numerous embodiments, at an edge-based network device, a method comprises collecting legitimate network traffic over a time period; learning a first set of features that represents the collected legitimate network traffic; generating synthetic network traffic based on the learned first set of features; and training a machine learning model based on the learned first set of features and the generated synthetic network traffic, wherein based on the training, the machine learning model learns a second set of features that differentiates the generated synthetic network traffic from the collected legitimate network traffic.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently disclosed embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which an anomaly detection logic may operate on a plurality of network devices in accordance with various embodiments of the disclosure;

FIG. 2 is a schematic diagram illustrating various subsets of artificial intelligence in accordance with various embodiments of the disclosure;

FIG. 3 is a block diagram illustrating different methods of machine-based learning in accordance with various embodiments of the disclosure;

FIG. 4 is a block diagram illustrating a machine learning lifecycle in accordance with various embodiments of the disclosure;

FIG. 5 is a schematic diagram illustrating an example neural network in accordance with various embodiments of the disclosure;

FIG. 6 is a block diagram illustrating an edge-based network device configured to perform wireless intrusion detection based on deep learning in accordance with various embodiments of the disclosure;

FIG. 7 is a block diagram illustrating a wireless intrusion detection system in accordance with various embodiments of the disclosure;

FIG. 8 is a flowchart depicting a process for training a machine learning model to classify network traffic for wireless intrusion detection in accordance with various embodiments of the disclosure;

FIG. 9 is a flowchart depicting a process for detecting an intrusion event at an edge-based network device in accordance with various embodiments of the disclosure;

FIG. 10 is a flowchart depicting a process for training statewise models for wireless intrusion detection in accordance with various embodiments of the disclosure;

FIG. 11 is a flowchart depicting a process for deploying statewise models for wireless intrusion detection in accordance with various embodiments of the disclosure; and

FIG. 12 is a conceptual block diagram of a device suitable for configuration with the anomaly detection logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems, devices, and methods are discussed herein for wireless intrusion detection based on deep learning. Wireless intrusion detection may refer to a process of monitoring and analyzing wireless network traffic, for example, Wi-Fi® network traffic, to identify threats such as malware, system vulnerabilities, or the like, and attacks such as unauthorized access, data breaches, Denial-of-Service (DoS) attacks, ransomware attacks, damage, or other malicious activities and intrusions. Network traffic may refer to data that is transmitted over a network, for example, a wireless network. Network traffic may stem from numerous different types of communication, for example, requests, responses, and data transmitted between devices on the network. The data associated with the network traffic may include, for example, files, messages, queries, system updates, or the like. Network traffic may be encapsulated in packets, which are units of data that provide a load in the network. Network traffic may be measured, for example, in terms of bandwidth usage, latency, and packet count. Network traffic may be classified, for example, as legitimate network traffic, corrupted network traffic, or anomalous network traffic, depending on its source and intent. The legitimate network traffic may refer to network traffic that may be authorized, expected, and typical for normal operations within the network. The legitimate network traffic may include, for example, packets of data from standard user activities, routine system processes, and communications that align with an intended use of the network. These packets may initiate from and/or may be destined for an authorized or uncompromised node of the network. The legitimate network traffic may be non-malicious and may comply with established network policies. Corrupted network traffic may refer to packets that have been altered, damaged, or otherwise degraded during transmission, typically due to errors or disruptions in the network. Anomalous network traffic may refer to network traffic that may deviate from normal patterns, often indicating unusual or suspicious behavior. The anomalous network traffic may include, for example, data associated with unexpected spikes in traffic, unusual data sources or destinations, or activities that may not align with typical user behavior.

Further, the anomalous network traffic may indicate security threats, for example, cyberthreats such as malware, attacks such as new or unknown attacks referred to as “zero-day attacks,” data breaches, or other forms of malicious activity. The term “zero-day” may indicate that a vendor or a developer has had zero days to address or resolve vulnerabilities or security flaws in a zero-day application, before the vulnerabilities or security flaws are exploited. The zero-day application may refer to a newly developed or updated application or software having vulnerabilities or security flaws that may be unknown to the vendor or the developer at the time they are discovered or exploited by attackers. Wireless intrusion detection may utilize anomaly detection to identify deviations from normal wireless network traffic patterns. These deviations can indicate various malicious activities and intrusions such as Distributed Denial-of-Service (DDoS) attacks, unauthorized data access, malware infections, or system intrusions among other cyberattacks such as zero-day attacks, Man-in-the-Middle (MitM) attacks, sniffing attacks, data exfiltration, malware, spoofing attacks, jamming, unauthorized devices trying to connect to the network, or the like. Detecting the anomalous network traffic may facilitate early identification of potential security breaches or cyberattacks, allowing organizations to mitigate risks before significant damage occurs. Moreover, accurately classifying different types of network traffic may help reduce the occurrence of false positives, which can overwhelm security systems and lead to unnecessary resource allocation. Without proper anomaly detection and classification systems, network administrators may be unable to efficiently monitor, analyze, and respond to threats or attacks in real time or near real time.

Based on their susceptibility to unauthorized access, wireless networks, for example, Wi-Fi® networks, may be inherently more vulnerable to attacks than wired networks. Conventional intrusion detection systems may fail to adequately protect the wireless networks against the ever-changing landscape of cyberattacks such as unauthorized entries, data compromises, and DoS attacks. These intrusion detection systems, which often depend on static rules or signature-based detection, may also not be capable of handling new types of attacks, leading to a high rate of false alarms. This challenge may be exacerbated by the complex and diverse nature of wireless network traffic, for example, Wi-Fi network traffic, making it difficult to accurately identify what constitutes normal behavior versus abnormal or anomalous behavior. Therefore, to protect the wireless networks from malicious activities and intrusions, there is a need for a more dynamic and resilient wireless intrusion detection system configured for wireless environments, for example, Wi-Fi network environments, and that may not only promptly and precisely detect potential security threats but may also reduce false positives, thereby ensuring a sensitive and accurate response to genuine anomalies. However, there may be several challenges in addressing this need, for example, crafting precise models to represent normal behavior within wireless protocols such as Wi-Fi protocols, distinguishing between legitimate activities and security threats effectively, navigating the inherent variability and complexity of wireless network traffic patterns, and efficiently monitoring the network traffic amidst increasing data volumes that may further compound the difficulty of ensuring effective network security measures.

Further, goals including scalability, high accuracy, and adaptability may not be achievable on a static system (where each application may be a configured static set of patterns) because such a static system may be unable to recognize new applications of the same type as other known applications (for example, recognizing a new voice application, because the model has learned the general idea on “how a voice application flow would look like”). Such dynamic learning may be possible with various structures, for example, with forward machine learning. However, such structures are heavy, with an outcome that the implementation must be a tradeoff between recognition speed, accuracy, and an ability to learn. Moreover, while machine learning may be applied to monitor large-scale networks from a centralized location or a centralized computational resource group, for example, the cloud, monitoring complex wireless networks through machine learning may require large numbers of computational resources performing a large number of computations, making centralized implementation of network monitoring using machine learning extremely challenging. There is therefore a need for distributing network monitoring through machine learning to computational resources at the edges of a network, away from the centralized location. Machine learning models, being large models, may not run on an edge-based device, for example, an access point, at the edge of the network, which may be required for improving response times and enabling real-time decision making for execution of immediate actions. An edge-based device may refer to a physical or virtual device located at the edge of the network, near a source of data generation or consumption. Relying on an external entity such as a controller or a cloud service and performing external processing for inspecting packets associated with the network traffic can introduce significant delays. Further, not all packets can be transferred, as the access point may first downsample the packets, which can result in the loss of information necessary for anomaly detection. Such delays and potential information loss may be unacceptable in wireless intrusion detection systems, as malicious actors may potentially inflict damage before the intrusion is detected.

The present disclosure addresses the above-mentioned challenges by providing systems, devices, and methods with integrated advanced machine learning techniques capable of classifying the network traffic and detecting intrusions, ensuring that organizations can better defend against cyber threats and cyberattacks while maintaining the efficiency and performance of their networks. In many embodiments, the systems, devices, and methods discussed herein may mitigate the susceptibility of wireless networks to a broad spectrum of cyber threats and cyberattacks. By devising an intrusion detection system tailored for wireless networks, the system, devices, and methods discussed herein may enhance security defenses of various applications and devices that depend on wireless networks for connectivity, thereby preserving the integrity and security of data and communication channels in an increasingly connected world.

In a number of embodiments, the systems, devices, and methods discussed herein may provide a Wireless Intrusion Detection (WID) system that leverages processing capabilities of one or more network devices to analyze packet streams such as Wi-Fi packet streams and distinguish normal behavior from anomalous behavior. In a variety of embodiments, the network device(s) may be an edge-based device, for example, an access point, configured with sufficient processing capabilities to inspect packets and make decisions internally, rather than outsourcing these tasks to an external entity such as a controller or a cloud service. In various embodiments, the WID system may utilize neural networks, for example, Generative Adversarial Networks (GANs), to discriminate between normal behavior and anomalous behavior, aiming to detect potential intrusions by identifying deviations from a pre-established baseline of normal network traffic patterns. By employing machine learning techniques such as deep learning, the WID system disclosed herein may enhance the ability to identify and respond to wireless network attacks such as Wi-Fi attacks that may exploit vulnerabilities in wireless protocols by deviating from normal behavior.

In more embodiments, the WID system may implement an anomaly detection-based mechanism, wherein deviations from the established baseline may be indicative of potential security threats. To develop an accurate model of normal wireless protocol behavior, the WID system may initially process wireless network traffic streams captured by the network device. By analyzing state transitions within the wireless network traffic, the WID system may construct a normal behavior state machine, encapsulating the normal behavior of a wireless protocol. To address the challenge of accurately capturing a diverse range of network behaviors, which may lead to the potential for high false alarms in anomaly detection systems, the WID system may implement a machine learning component in the form of a neural network, for example, a GAN. In additional embodiments, the GAN may be trained on the normal behavior state machine to distinguish between normal and anomalous activities within the wireless network. By utilizing the power of adversarial learning, the GAN may enhance the capability of the WID system to discern subtle deviations in the behavior of the wireless network, thereby improving the detection accuracy of potential wireless network attacks. Further, through iterative training, the GAN may adapt to evolving network dynamics, ensuring robust intrusion detection performance over time.

In further embodiments, the WID system may be implemented with a dedicated architecture including a specific structure, for example, a neural processing unit/tensor structure, for running one or more machine learning models on the edge-based device at the edge of the wireless network. The edge-based device may be responsible for processing, analyzing, or storing data locally, often without needing to transmit all the data to a central server or the cloud. The edge-based device may be configured to perform computations or data processing locally or closer to where the data originates, reducing latency, conserving bandwidth, improving security, and enabling real-time decision-making. In still more embodiments, running the machine learning models on the edge-based device may facilitate the processing of data locally on the edge-based device, which may reduce the time for transmitting the data to the central server or the cloud, thereby substantially improving response times and enabling real-time decision-making. Moreover, running the machine learning models on the edge-based device may reduce the need for expensive cloud infrastructure and reduce the strain on central servers, allowing for better scalability in large-scale deployments. Further, local processing may allow sensitive data to remain on the edge device rather than being transmitted over the network, which can enhance privacy and security by reducing exposure to potential breaches during transmission.

By leveraging machine learning techniques, the WID system may improve the detection accuracy of potential security threats in wireless networks, including both known and new or unknown types of attacks. Moreover, the utilization of the GAN may allow the WID system to adapt to evolving threats, attack techniques, and network dynamics, ensuring robust intrusion detection capabilities over time. Further, through anomaly score aggregation and thresholding mechanisms, the WID system may mitigate false alarms, minimizing disruptions to network operations and reducing the burden on network administrators. With anomaly detection, the WID system may learn the normal behavior and can flag anything outside of the established baseline, including previously unseen attack methods. By detecting anomalies that impact the performance of the wireless network, such as sudden spikes in traffic or congestion, the WID system can help network administrators proactively manage network traffic, ensuring that the network operates efficiently without disruption.

In still further embodiments, the WID system may be configured for wireless environments, for example, Wi-Fi network environments, and may not only promptly and precisely detect potential security threats but may also reduce false positives, thereby ensuring a sensitive and accurate response to genuine anomalies. The WID system may generate precise machine learning models to represent normal behavior within wireless protocols, distinguish between legitimate activities and security threats effectively, navigate the inherent variability and complexity of wireless network traffic patterns, and efficiently monitor the network traffic amidst increasing data volumes, thereby allowing implementation of robust network security measures.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in some more embodiments, may alternatively be embodied by or implemented as a component.

A circuit, as used herein, comprises a set of one or more electrical and/or electronic components providing one or more pathways for electric current. In still additional embodiments, a circuit may include a return pathway for electric current, so that the circuit is a closed loop. In some more embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In yet various embodiments, a circuit may include a portion of an integrated circuit, an integrated circuit, a set of integrated circuits, a set of non-integrated electrical and/or electrical components with or without integrated circuit devices, or the like. In yet more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in still yet more embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

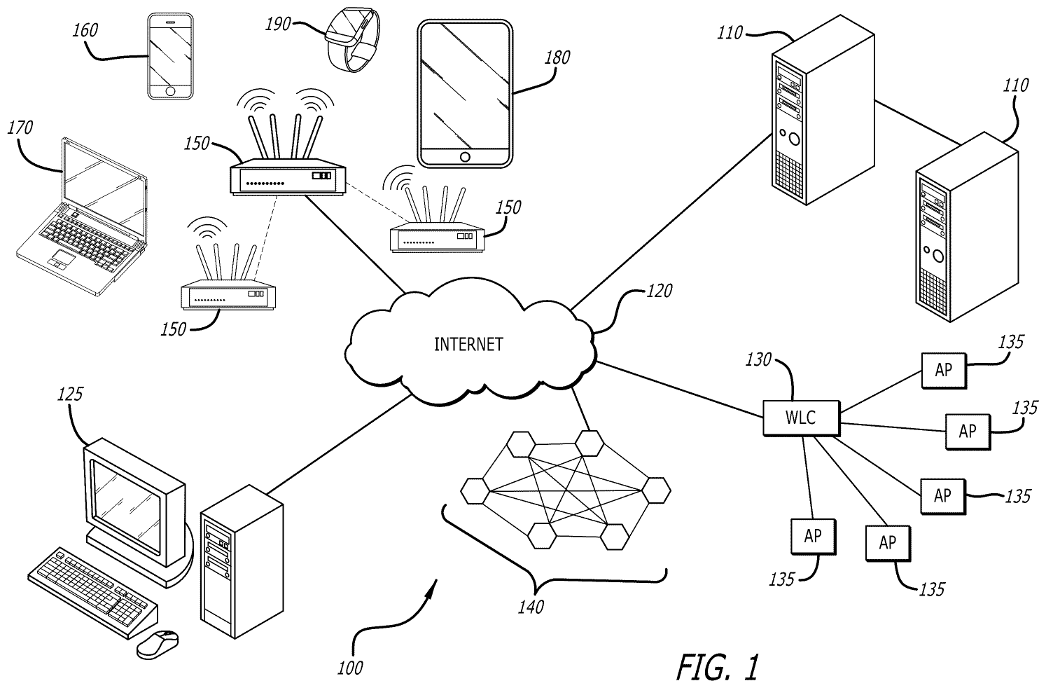

Referring to FIG. 1, a conceptual network diagram 100 of various environments in which an anomaly detection logic may operate on a plurality of network devices in accordance with various embodiments of the disclosure is shown. Those skilled in the art will recognize that the anomaly detection logic can include various hardware and/or software deployments and can be configured in a variety of ways. In many embodiments, the anomaly detection logic can be configured as a standalone device, exist as a logic in another network device, be distributed among various network devices operating in tandem, or be remotely operated as part of a cloud-based network management system. In a number of embodiments, one or more servers 110 can be configured with the anomaly detection logic or can otherwise operate as the anomaly detection logic. In a variety of embodiments, the anomaly detection logic may operate on one or more servers 110 connected to a communication network 120 (shown as the “Internet”). The communication network 120 can include wired networks or wireless networks. The anomaly detection logic can be provided as a cloud-based service that can service remote networks, such as, but not limited to a deployed network 140.

In various embodiments, the anomaly detection logic may be operated as a distributed logic across multiple network devices. In the embodiment depicted in FIG. 1, a plurality of access points 150 can operate as the anomaly detection logic in a distributed manner or may have one specific device operate as the anomaly detection logic for all the neighboring or sibling access points 150. The access points 150 may facilitate Wi-Fi® connections for various electronic devices, such as but not limited to, mobile computing devices including cellular phones 160, laptop computers 170, portable tablet computers 180, and wearable computing devices 190.

In more embodiments, the anomaly detection logic may be integrated within another network device. In the embodiment depicted in FIG. 1, a Wireless Local Area Network (LAN) Controller (denoted as “WLC”) 130 may have an integrated networking logic that the WLC 130 can utilize to monitor or control power consumption of a plurality of access points (denoted as “APs”) 135 to which the WLC 130 is connected, via either a wired connection or a wireless connection. In additional embodiments, a personal computer 125 may be utilized to access and/or manage various aspects of the anomaly detection logic, either remotely or within the communication network 120 itself. In the embodiment depicted in FIG. 1, the personal computer 125 communicates over the communication network 120 and can access the anomaly detection logic of the one or more servers 110, or the access points 150, or the WLC 130.

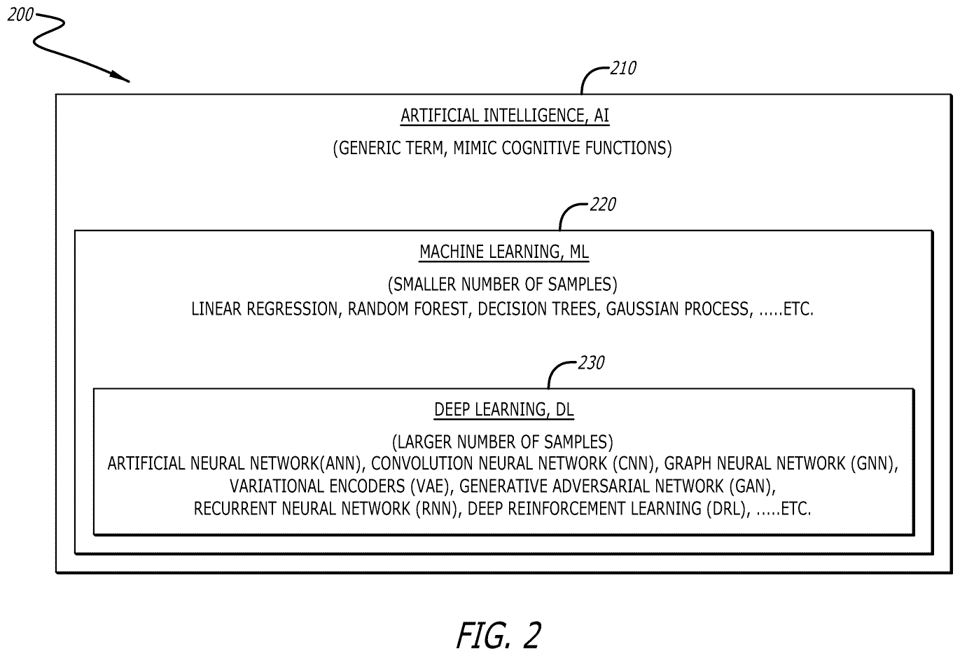

Although a specific embodiment for various environments in which an anomaly detection logic may operate on a plurality of network devices suitable for carrying out the various steps, processes, methods, and operations described herein is discussed with respect to FIG. 1, any of a variety of systems and/or processes may be utilized in accordance with embodiments of the disclosure. For example, the anomaly detection logic may be provided as a device or a software separate from the WLC 130 or the anomaly detection logic may be integrated into the WLC 130. The elements depicted in FIG. 1 may also be interchangeable with other elements of FIGS. 2-12 as required to realize a particularly desired embodiment.

Referring to FIG. 2, a schematic diagram 200 illustrating various subsets of artificial intelligence in accordance with various embodiments of the disclosure is shown. Artificial intelligence (AI) 210 is typically understood in the art to be the development of machines and algorithms that mimic human intelligence, for example, by optimizing actions to achieve certain goals. At its core, AI 210 often involves designing algorithms and models that mimic cognitive functions, such as learning, reasoning, problem-solving, perception, and even language understanding. Unlike conventional computer programs that follow a fixed set of instructions, AI systems can adapt, improve, and make decisions based on input data and environmental interactions.

AI 210 can be considered a generic term because AI 210 encompasses a wide range of subfields and techniques, from simple rule-based systems to advanced machine learning and deep learning models. These AI techniques are utilized for simulating various aspects of human cognition. For example, Machine Learning (ML) 220 allows computers to learn from data patterns without explicit programming for each task, while Natural Language Processing (NLP) enables machines to understand and generate human language. Deep learning (DL) 230, a more advanced branch of AI 210, utilizes neural networks to automatically learn complex patterns from large datasets, akin to information processing by the human brain. This versatility makes AI 210 a powerful tool across diverse applications, including network traffic classification, anomaly detection-based wireless intrusion detection, image recognition, autonomous driving, voice assistants, healthcare diagnostics, and materials discovery.

A goal of AI 210 is often to create systems that can function autonomously and intelligently in real-world scenarios. As AI 210 continues to evolve, AI 210 can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 220 is a subset of AI 210 that focuses on the development of algorithms and statistical models that enable computers to learn and make decisions from data without explicit programming. In conventional programming, a computer is given a fixed set of rules to follow, but ML 220 can shift this paradigm by allowing systems to identify patterns, adapt, and improve their performance based on the data they encounter. This data-driven approach makes ML 220 particularly valuable for tasks that are too complex or dynamic to define using straightforward rules, such as determining patterns associated with network traffic, recognizing images, predicting consumer behavior, or diagnosing diseases. In various embodiments described herein, machine-learning methods may be utilized to differentiate synthetic network traffic from legitimate network traffic, and further to classify the network traffic as legitimate network traffic, corrupted network traffic, or anomalous network traffic.

ML models can be configured to analyze large amounts of data to identify trends and relationships that inform their predictions or classifications. The process typically involves three stages: training, validation, and testing. During training, the ML model learns from a dataset by adjusting its internal parameters to minimize errors between its predictions and the actual results. Techniques such as linear regression, decision trees, random forests, and Gaussian processes are commonly utilized in ML 220. These algorithms can handle various data types, including numerical, categorical, and structured datasets such as spreadsheets or grids. One of the strengths of ML 220 is its ability to generalize from training data to make accurate predictions on new, unseen data. In many embodiments described herein, training data may be generated from a normal behavior state machine that establishes a baseline of normal network traffic patterns, among other sources.

However, conventional ML methods may rely heavily on feature engineering, wherein human experts manually identify the most relevant features or patterns within the data. For example, when using ML 220 for classifying network traffic, an expert may need to extract features such as header characteristics, payload characteristics, temporal characteristics, state transition characteristics associated with the legitimate network traffic, or the like, before feeding them into the ML model. This requirement can limit the scalability of conventional ML approaches, especially when dealing with large, unstructured datasets such as images, text, or graphs. Additionally, ML algorithms may often work best when provided with relatively structured data, and they often need a reasonable number of samples (typically more than 100) to learn effectively.

DL 230 is a specialized subset of ML 220 that employs multi-layered artificial neural networks to automatically learn complex patterns and representations from large, often unstructured datasets. Inspired by the way the human brain processes information, DL 230 includes interconnected layers of “neurons” that can adaptively change as they are exposed to more data. Unlike conventional ML methods, which require manual feature engineering to identify data characteristics, DL models can automatically extract features directly from raw data, such as images, text, or molecular structures. This automated feature extraction allows DL 230 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as network traffic, molecular structures, atomic interactions, loads, or the like. GNNs can learn the dependencies and relationships within graph-like structures, which may facilitate predicting properties of complex patterns, molecules, and materials. For example, the features of packets constituting the network traffic are modeled as a graph, which may be input into a GNN for classifying the network traffic as legitimate network traffic, corrupted network traffic, or anomalous network traffic. By organizing the features of the packets into a graph structure, situations where new or unseen patterns generated by newly developed or updated applications, referred to as “zero-day” applications, are unknown, may be handled optimally. RNNs and their variants, such as Long Short-Term Memory (LSTM) networks, are suited for sequential data such as time series or NLP, allowing for the analysis and generation of textual information or the prediction of temporal patterns in scientific research.

One of the defining characteristics of DL 230 is its requirement for large datasets (typically over 500 samples for example) to effectively train neural networks. While the deep, multi-layered structure of these networks enables them to capture highly complex and abstract representations of the data, they also demand significant computational power. Techniques such as Variational Autoencoders (VAEs) and Generative Adversarial Networks (GANs) add to the versatility of DL 230 by enabling the generation of new data samples that resemble a training dataset, aiding in areas such as materials discovery and synthetic data creation. Deep Reinforcement Learning (DRL) combines neural networks with decision-making processes to solve problems that involve optimization and control, further expanding the application potential of DL 230. In summary, the ability of DL 230 to automatically learn from raw, unstructured data and model intricate patterns makes DL 230 a powerful tool in AI 210, particularly for complex domains such as image recognition, NLP, and materials science.

Artificial Neural Networks (ANNs or sometimes merely NNs) are often a foundation of a DL system. The basic unit of a neural network is typically a perceptron, which can take inputs, assigns weights to these inputs, and combines them to produce an output. The final output is then passed through an activation function, for example, a Rectified Linear Unit (ReLU), a sigmoid, or a hyperbolic tangent, to introduce non-linearity, which enables the network to model complex patterns.

Neural networks are typically trained through a process of backpropagation, where predictions of an AI system are compared against a known output, and a loss function is utilized to measure the difference between the prediction and the actual result. The weights assigned by the neural network can be adjusted through a process called gradient descent, which can be configured to minimize the loss function over time. However, the training process can be prone to problems such as overfitting (where the ML model performs well on the training data but poorly on new data). To counter this, techniques such as regularization (e.g., dropout), early stopping, and mini-batches can be utilized to prevent the neural network from becoming overly specialized to the training dataset.

CNNs are a specific type of ML neural network designed to work particularly well with network data, making them highly relevant for classifying network traffic, which may be subject to processing. As those skilled in the art will recognize, CNNs typically utilize specialized layers known as convolutional layers, which apply filters (also known as kernels) to the input data. These filters slide over the input (e.g., an input power value), detecting patterns such as edges or textures, which are then passed to the next layer for further processing. CNNs can automatically learn and extract relevant features from raw data without the need for manual feature engineering. Furthermore, pooling layers (e.g., max-pooling or average pooling) are often added after convolutional layers to reduce the dimensionality of the data, helping to make the AI system more efficient while retaining the most important information. After several layers of convolutions and pooling, the CNN can output a prediction, such as whether the network traffic is legitimate network traffic, corrupted network traffic, or anomalous network traffic.

While CNNs are well-suited for grid-based data like images, many real-world problems can involve non-grid data, such as packet data or the like. This type of data may better be represented as a graph, where nodes represent entities (e.g., network devices, Internet Protocol “IP” addresses, applications, or the like) and edges represent relationships between them (e.g., communication patterns or data flows between the network devices and the applications). Thus, Graph Neural Networks (GNNs) can be utilized to operate on such graph-based data.

In GNNs, information is passed between the nodes through the edges in a process called message passing. This allows the neural network to capture dependencies and relationships within the graph structure. GNNs can aggregate information from neighboring nodes, which is utilized in predicting properties that depend on the current/local structure, such as the behavior of the applications or the properties of the devices.

Generative models aim to learn the underlying distribution of a dataset and generate new samples that resemble the original data. Two common types of generative models are VAEs and GANs. VAEs are often configured to work by encoding data into a lower-dimensional latent space and then decoding the data back into its original form, which allows for the generation of new data by sampling points from the latent space. This can be utilized when attempting to construct a graph based on features of the packets and the network devices or applications. Similarly, GANs include two components: a generator that creates fake or generated data and a discriminator that attempts to distinguish between real data and fake data. The two components are trained in a competitive process where the generator attempts to “fool” the discriminator, leading to increasingly realistic generated data. This type of process may be utilized to produce synthetic samples that resemble the training data, which can help augment the training dataset.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex network traffic simulations.

In network traffic classification, DRL can be utilized in scenarios where an optimal decision needs to be made, such as classifying network traffic as legitimate network traffic, corrupted network traffic, and anomalous network traffic based on various features such as packet headers, data flow characteristics, etc. The combination of RL and DL 230 can allow for learning from raw data, making it a powerful tool for dynamic and real-time decision-making for network traffic classification.

Although a specific embodiment for various subsets of artificial intelligence suitable for carrying out the various steps, processes, methods, and operations described herein is discussed with respect to FIG. 2, any of a variety of systems and/or processes may be utilized in accordance with embodiments of the disclosure. For example, another subset such as transformer networks, capsule networks, or the like may be present and available for use within AI 210. Those skilled in the art will recognize that the schematic diagram 200 presented in FIG. 2 is simplified for illustration purposes and various methods and techniques may interact with other areas (ML 220 with DL 230, etc.). The elements depicted in FIG. 2 may also be interchangeable with other elements of FIG. 1 and FIGS. 3-12 as required to realize a particularly desired embodiment.

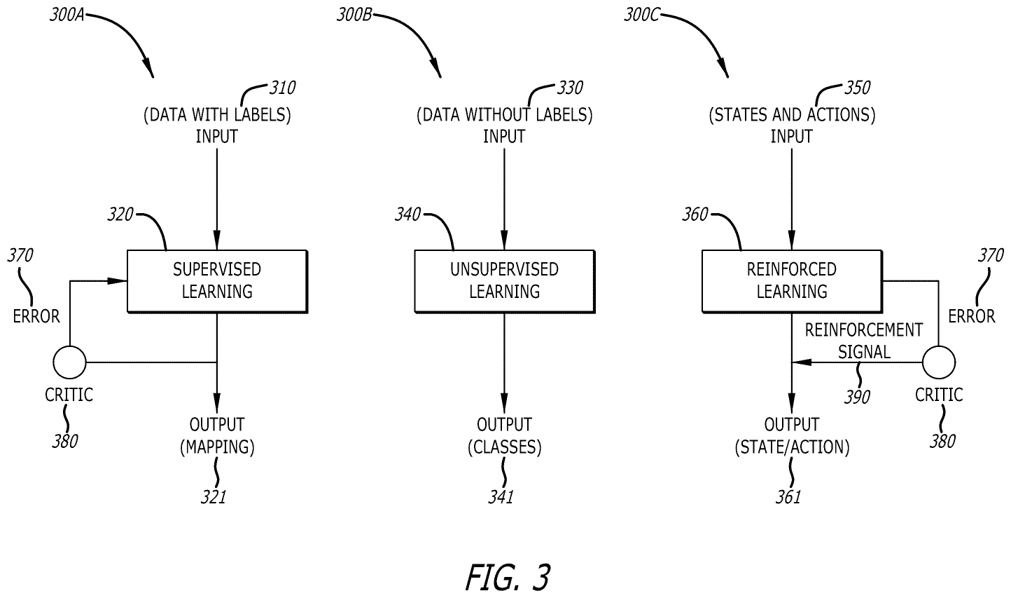

Referring to FIG. 3, a block diagram illustrating different methods of machine-based learning in accordance with various embodiments of the disclosure is shown. In many embodiments, a machine learning model is defined as a mathematical representation of an output of a training process. An ML model is often considered similar to computer software designed to recognize patterns or behaviors based on previous experience or data. An ML algorithm can discover patterns within training data, and output an ML model which can capture these patterns and make predictions on new data.

ML models may be interpreted as devices that have been trained to find patterns within new data and make predictions. These ML models can be represented as complex mathematical functions that would be impractical for a human to calculate, that takes requests in the form of input data, makes predictions on input data, and then provides an output in response. These ML models can be trained over a set of data, and then they may be provided an algorithm or other task to reason over the data, extract patterns from feed data, and learn from that data. Once the ML models are trained, they can be utilized to predict a new and previously unseen dataset.

There are various types of ML models available based on different business goals and datasets available. Often, based on the desired application, ML models can be configured as or settled into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 3, a supervised learning system 300A is shown. The supervised learning system 300A can be configured with a supervised learning model 320 that accepts input data 310 and generates output data 321. The output data 321 is often reviewed by a critic 380 that can determine an error 370 that is fed back into the supervised learning model 320 for use in updating.

Supervised learning systems 300A are often considered the simplest ML model to understand which input data (such as training data) has a known label or result as an output. The supervised learning model 320 can, therefore, be understood to work on the principle of input-output pairs. As such, a function can be trained using a training dataset, which is then applied to unknown data to make some predictions. Supervised learning is task-based and mostly tested on labeled datasets.

Supervised learning systems 300A may often involve one or more regression problems. In regression problems, the output is a continuous variable. Examples of commonly utilized regression models include linear regression, decision trees, and random forests. Linear regression is typically the most straightforward ML model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this linear equation may be represented in the form of a line: y=bx+c. A typical aim of a linear regression-based model can be to find an optimal fit line that best fits available data points. Linear regression can be extended to multiple linear regressions (finding a plane of best fit in a higher dimensional space) and polynomial regressions (finding the best fit curve).

Decision trees are also popular ML models that can be utilized for both regression and classification problems. A decision tree utilizes a tree-like structure of decisions along with their possible consequences and outcomes. In a decision tree, each internal node is utilized to represent a test on an attribute while each branch is utilized to represent the outcome of the test. The more nodes a decision tree has, the more accurate the result will be. This may be utilized when making decisions related to network traffic and their separation. Decision trees are intuitive and easy to implement, but may lack accuracy depending on computational or time resources available.

Random forests are an ensemble learning method, which may include a large number of decision trees. For example, each decision tree in a random forest predicts an outcome, and the prediction with a majority of votes is considered as the outcome. A random forest model can be utilized for both regression and classification problems. For a classification task, the outcome of the random forest may be taken from the majority of votes. Whereas in a regression task, the outcome can be taken from a mean or an average of the predictions generated by each tree.

Classification models are the other type of supervised learning, which can be utilized for generating conclusions from observed values in one or more categorical forms. For example, a classification model can identify if an email is spam or not; whether network traffic is legitimate, corrupted, or anomalous, etc. Classification algorithms can also be utilized for predicting between two or more classes and/or categorize an output into different groups. For these classification systems, a classification model can be designed that classifies a dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be utilized for solving various classification problems in machine learning systems. These processes are similar to linear regression but are often utilized for predicting categorical variables. While some variations can be configured to generate a prediction as an output in either “yes” or “no,” 0 or 1, “true” or “false,” etc., in a number of embodiments, the system can instead be configured to not give exact values, but instead provide probabilistic values between zero and one.

Another classification process that can be utilized is a Support Vector Machine (SVM) which is widely utilized for classification and regression tasks. However, the main aim of the SVM is to find the best decision boundaries in an N-dimensional space, which can be utilized for segregating data points into classes, and generate a best decision boundary often known as a hyperplane. SVM processes can select an extreme vector to find a hyperplane, wherein this vector is known as a support vector.

Naïve Bayes is another popular classification algorithm utilized in machine learning. This classification process is based on Bayes' theorem and follows a naïve (independent) assumption between features which is often based on the following formula:

$$P ( y \vert X ) = \frac{P ( X \vert y ) * P ( y )}{P ( X )}$$

This formula takes a class or target y and a predictor attribute (X) and calculates a posterior probability P (y|X) of that class given a particular predictor. P(y) is the prior probability of that class, P (X) is the prior probability of the predictor, and P(X|y) is the likelihood or probability of the predictor given the class. As those skilled in the art will recognize, this may be more succinctly understood as a posterior chance being a result of prior results times the likelihood divided by evidence available. Each Naïve Bayes classifier assumes that the value of a specific variable is independent of any other variable/feature. For example, if a fruit needs to be classified based on color, shape, and taste, yellow, oval, and sweet will be recognized as mango. In this example, each feature is independent of other features. Likewise, various embodiments herein can classify the network traffic into categories such as web traffic, File Transfer Protocol (FTP) traffic, streaming traffic, social media traffic, gaming traffic, or the like, which may constitute legitimate network traffic, corrupted network traffic, or anomalous network traffic.

Further, in the embodiment depicted in FIG. 3, an unsupervised learning system 300B is shown. The unsupervised learning system 300B can be configured with an unsupervised learning model 340 that accepts input data 330 and generates an output 341. Unlike other model types, there are no critics or error signals to process. Unsupervised learning models 340 can implement a learning process opposite to supervised learning, which means the learning process enables a model to learn from an unlabeled training dataset. Based on the unlabeled training dataset, the unsupervised learning model 340 can predict the output 341. Using the unsupervised learning system 300B, the unsupervised learning model 340 can learn hidden patterns from the unlabeled training dataset by itself without any supervision. In a variety of embodiments, unsupervised learning models 340 are often utilized for performing tasks involving clustering, association rule learning, and/or dimensional reduction.

Clustering is an unsupervised learning technique that involves clustering or grouping the available data points into different clusters based on similarities and/or differences. The data points or objects with the most similarities remain in the same group, and they have no or very few similarities from other groups. Clustering algorithms can be utilized in various tasks such as, but not limited to image segmentation, statistical data analysis, market segmentation, or the like. Some commonly utilized clustering algorithms that can be selected include, for example, K-means clustering, hierarchal clustering, Density-based Spatial Clustering of Applications with Noise (DBSCAN), etc.

Association rule learning is an unsupervised learning technique which finds unique relations among variables within a large dataset. In various embodiments, a primary aim of this type of learning algorithm is to find a dependency of one data item on another data item and map those variables accordingly to satisfy a desired outcome. For example, in more embodiments, an association rule system may be utilized for grouping packets extracted from the network traffic into clusters and categorizing them. This learning algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and Frequent Pattern (FP)-growth algorithm.

In additional embodiments, the number of features/variables present in a dataset can be understood as the dimensionality of the dataset, and the technique utilized to reduce the dimensionality is known as a dimensionality reduction technique. Although more data provides more accurate results, more data can also affect the performance of the model/algorithm, for example, by yielding overfitting outcomes. In such cases, dimensionality reduction techniques can be utilized. Dimensionality reduction techniques involve converting a higher-dimensional dataset into a lower-dimensional dataset while also ensuring that the ensuing results provide similar information. Different dimensionality reduction methods can be utilized, such as, but not limited to, Principal Component Analysis (PCA), Singular Value Decomposition (SVD), etc.

Further, in the embodiment depicted in FIG. 3, a reinforcement learning system 300C is shown. The reinforcement learning system 300C can be configured with a reinforcement learning model 360 that accepts input data 350 and generates an output 361. In reinforcement learning, the reinforcement learning model 360 learns actions for a given set of states that lead to a goal state. In the embodiment depicted in FIG. 3, a critic 380 can receive or otherwise notice an error 370 within the reinforcement learning model 360 actions, and transmit a reinforcement signal 390 to adjust the outcome/output such that the “reward” or “punishment” is adjusted to better model the future behaviors or processing of the reinforcement learning model 360.

The reinforcement learning model 360 is a feedback-based learning model that can take feedback signals after each state or action by interacting with the environment. This feedback works as a reward (positive for each good action and negative for each bad action), and an AI agent's goal is to maximize the positive rewards to improve their performance. The behavior of the reinforcement learning model 360 in reinforcement learning is similar to that of human learning, as humans learn things by experiences as feedback and interact with an environment. Popular methods of reinforcement learning including Q-learning, State-Action-Reward-State-Action (SARSA), and deep Q network.

Q-learning is one of the popular model-free algorithms of reinforcement learning, which is based on the Bellman equation. Q-learning often aims to learn a policy that can help an AI agent to take the best action for maximizing a reward under a specific circumstance. Q-learning can incorporate a Q-value for each state-action pair that indicates the reward to following a given state path, and tries to maximize that Q-value.

SARSA is an on-policy algorithm based on the Markov decision process. In further embodiments, SARSA can use the action performed by the current policy to learn the Q-value. The SARSA algorithm stands for State Action Reward State Action, which symbolizes the tuple (s, a, r, s′, a′). A Deep Q-Network (or DQN) implements Q-learning within a neural network. The DQN can be deployed within a big state space environment where defining a Q-table would be a complex task. In these embodiments, rather than using a Q-table, the DON utilizes Q-values for each action based on the state.

Although a specific embodiment for different methods of machine-based learning suitable for carrying out the various steps, processes, methods, and operations described herein is discussed with respect to FIG. 3, any of a variety of systems and/or processes may be utilized in accordance with various embodiments of the disclosure. For example, those skilled in the art will recognize that methods of learning described herein are generalized and may incorporate other types developed as well as a combination of one or more methods based on the goals of the desired application. The elements depicted in FIG. 3 may also be interchangeable with other elements of FIGS. 1-2 and FIGS. 4-12 as required to realize a particularly desired embodiment.

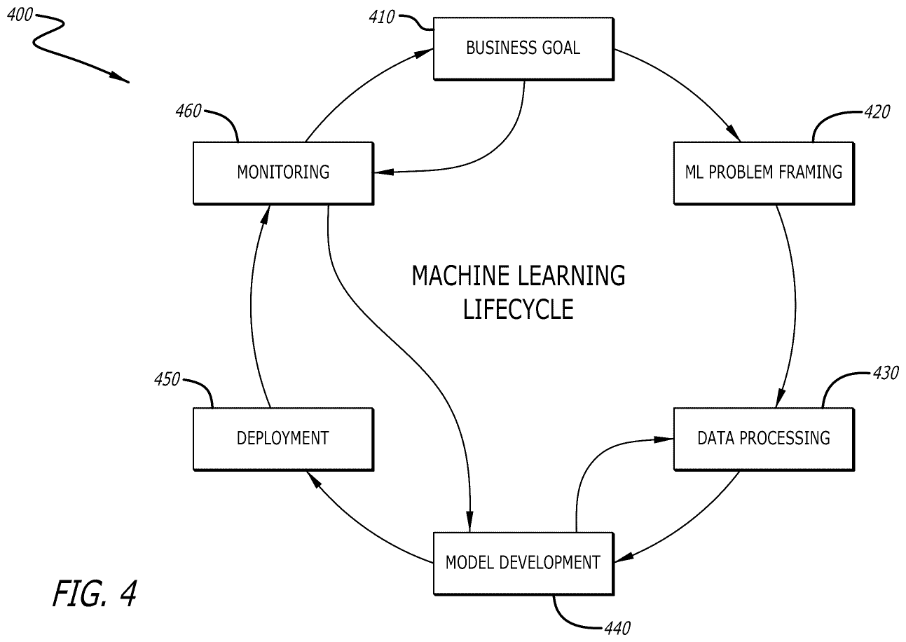

Referring to FIG. 4, a block diagram illustrating a machine learning lifecycle 400 in accordance with various embodiments of the disclosure is shown. While developing machine learning systems, the embodiment depicted in FIG. 4 can provide a framework for structuring the design and maintenance of these machine learning systems. The machine learning lifecycle 400 outlines various stages involved in building, deploying, and improving ML models to solve real-world problems. By following this structured process, businesses and organizations can ensure that their ML projects align with strategic goals, utilize data effectively, and adapt to changing conditions over time. This machine learning lifecycle 400 emphasizes that developing an ML model is not a one-time effort but an iterative process requiring ongoing monitoring and adjustment. A feedback loop inherent in the machine learning lifecycle 400 allows for continual refinement and optimization of the ML models to maintain their accuracy and relevance.

In many embodiments, a first stage of the machine learning lifecycle 400 includes identifying a business goal 410, which sets an overall direction and purpose for an ML project. Identifying the business goal 410 can involve understanding specific problems or opportunities within a business or a project that machine learning can address. A clear business goal 410 ensures that the project remains focused on delivering tangible value, whether it is classifying different types of network traffic or distinguishing between legitimate network traffic, corrupted network traffic, and anomalous network traffic. Without a well-defined business goal 410, it can be challenging to align subsequent stages of the machine learning lifecycle 400, as the choice of model, data processing methods, and performance metrics can all depend on what the business aims to achieve.

Establishing a proper business goal 410 can also involve engaging with key stakeholders and developers to gather requirements and set success criteria, which can provide a roadmap that outlines what success looks like and helps in framing an ML problem. For example, if the goal is to classify network traffic as legitimate network traffic, corrupted network traffic, or anomalous network traffic and detect anomalies, the project may focus on developing an ML model that utilizes a normal behavior state machine as input for distinguishing between normal behavior and anomalous behavior in wireless networks. Clearly defined business goals not only help guide the project but also provide benchmarks for evaluating the effectiveness of the deployed ML model once the deployed ML model enters production.

Once the business goal 410 is established, various embodiments take a next step involving ML problem framing 420, wherein the business goal 410 is translated into a specific machine learning task. This can involve selecting the appropriate type of ML problem, such as classification, regression, clustering, or recommendation, and defining target variables or outputs. For example, if the business goal 410 is to classify network traffic as legitimate network traffic, corrupted network traffic, or anomalous network traffic, the problem can be framed as a regression task where the ML model treats features of at least one packet in the network traffic such as packet header information, payload characteristics, temporal patterns, or the like as variables and an aggregate score as a metric for detecting an intrusion event. Proper ML problem framing 420 determines particular data requirements, choice of model, and evaluation metrics.

During the stage of ML problem framing 420, it is also prudent to consider constraints and assumptions that may affect the development of the ML model. The constraints and assumptions may include, for example, data availability, computational resources, ethical considerations, or regulatory compliance. Properly framing the ML problem ensures that the development of the ML model aligns with the needs of the business and that the ML problem is broken down into manageable steps, ultimately increasing the project's chances of success.

Data processing 430 is a stage in many embodiments where raw data is collected, cleaned, and transformed into a format suitable for machine learning. This stage of the machine learning lifecycle 400 can involve gathering data from various sources, removing errors or inconsistencies, handling missing values, and normalizing or scaling features to ensure that the ML model can learn effectively. Feature engineering is often a part of this stage, where new features are derived from the raw data to capture more relevant information and improve model performance.

The quality and preparation of the utilized data can significantly impact the accuracy and reliability of the ML model. Inadequate or poorly processed data can lead to biased or inaccurate predictions, no matter how advanced the ML model is. Hence, data processing 430 can require or at least benefit from careful planning and iterative refinement. Once the data is processed, the data is typically split into training, validation, and test datasets to develop and evaluate the ML model, ensuring that the ML model generalizes well to new, unseen data.

Model development 440 is a stage, in a number of embodiments, where machine learning algorithms are selected, trained, and refined to create an ML model that addresses the framed problem. This stage can involve choosing an appropriate algorithm (e.g., decision trees, neural networks, support vector machines, or the like), setting up the architecture of the ML model, and defining hyperparameters that will guide the training process. The ML model is trained on the processed data to identify patterns and relationships that allow the ML model to make predictions or decisions.

During model development 440, the ML model can be evaluated using the validation dataset to finetune its parameters and improve performance. Techniques such as cross-validation, regularization, and hyperparameter tuning can be utilized to prevent overfitting and ensure the ML model generalizes well. If proper steps are taken, the result is an ML model that, once the ML model meets predefined performance metrics, is ready for deployment in a real-world environment. However, model development 440 often involves several iterations to optimize the ML model for the specific business goal, indicated by an arrow directed back to data processing 430.

In a variety of embodiments, deployment 450 is the stage of the machine learning lifecycle 400 where the developed ML model is integrated into a production environment to perform its intended tasks. This stage may involve setting up necessary infrastructure, such as Application Programming Interfaces (APIs) or cloud-based services, to allow the ML model(s) to process live data and generate predictions. Deployment 450 can transform the ML model from a research tool into a functional component of a business process or product, providing real-time insights, automations, or decisions.

Proper deployment 450 can also include setting up mechanisms for logging, error handling, and user access. Since real-world environments are often dynamic and differ from training conditions, deployment 450 may require continuous adaptation and updates to ensure the ML model(s) operates efficiently. This stage may define the success of the ML model because the ML model's success is not only determined by its performance metrics but also by its ability to provide actionable results that align with the business goal 410.

In various embodiments, monitoring 460 is an ongoing process of tracking the performance and behavior of the ML model after deployment 450. Monitoring 460 involves collecting data on the ML model's predictions, accuracy, latency, and error rates to detect issues such as concept drift, where changes in the underlying data patterns can degrade the accuracy of the ML model. By continuously monitoring 460, teams can identify when the performance of the ML model drops and requires retraining or adjustments to align with evolving data.

Monitoring 460 can also encompass aspects such as user feedback, security, and compliance, ensuring that the ML model remains effective, reliable, and ethical in its application. Monitoring 460 may serve as a feedback loop in the machine learning lifecycle 400, where insights gained from monitoring feedback into the earlier stages of the machine learning lifecycle 400, particularly data processing 430 and model development 440, to refine the ML model(s) as needed. This iterative process allows a machine learning system to adapt and maintain its alignment with the original business goal 410 over time.

Although a specific embodiment for a machine learning lifecycle 400 suitable for carrying out the various steps, processes, methods, and operations described herein is discussed with respect to FIG. 4, any of a variety of systems and/or processes may be utilized in accordance with embodiments of the disclosure. For example, the particular route of development of the ML model(s) may not follow this machine learning lifecycle 400 completely. As those skilled in the art will recognize, there are a variety of ways to develop AI products that include various iterative steps that aid in development and refinement of different ML models. The elements depicted in FIG. 4 may also be interchangeable with other elements of FIGS. 1-3 and FIGS. 5-12 as required to realize a particularly desired embodiment.

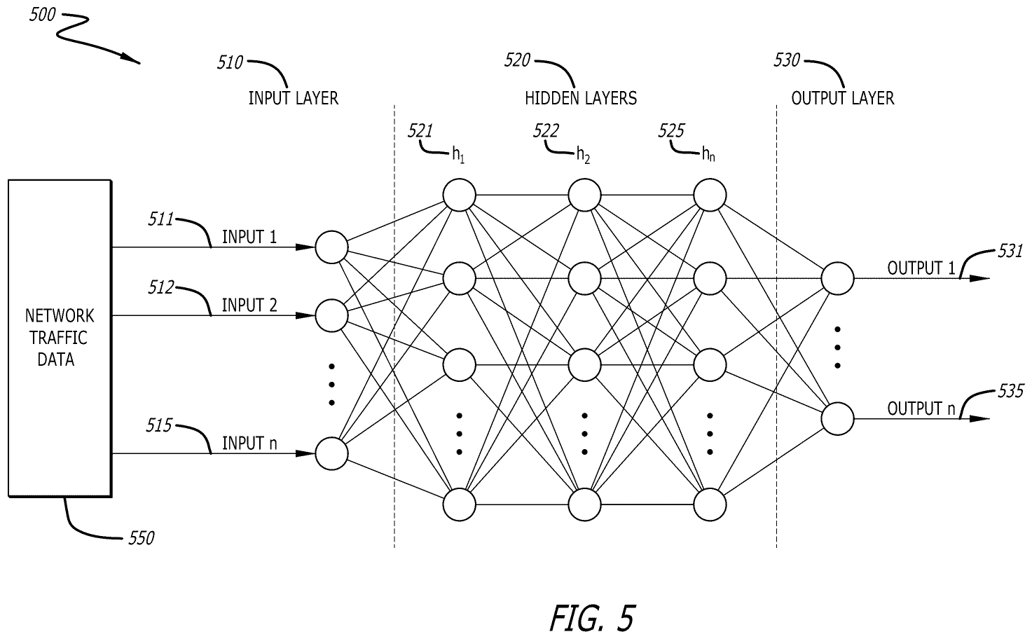

Referring to FIG. 5, a schematic diagram illustrating an example neural network 500 in accordance with various embodiments of the disclosure is shown. The embodiment illustrated in FIG. 5 specifically depicts a feedforward neural network with multiple layers. This type of network includes an input layer 510, one or more hidden layers 520, and an output layer 530. Each layer contains nodes (or neurons) that are interconnected, representing how data flows through the feedforward neural network. The input layer 510 can receive raw network traffic data 550, which is then processed by the hidden layers 520 through weighted connections and activation functions. These hidden layers 520 can enable the feedforward neural network to learn complex patterns and relationships within the network traffic data 550.

The final output layer 530 produces predictions or classifications of the feedforward neural network based on the processed network traffic data. The interconnected nature of the nodes allows the neural network 500 to learn from the network traffic data 550 during training by adjusting weights of connections to minimize prediction errors. This structure is the foundation of deep learning models, as adding more hidden layers 520 can create a deep neural network, capable of tackling highly complex tasks such as image recognition, NLP, and pattern detection in large datasets.

A perceptron or a single artificial neuron is the building block of ANNs and can perform forward propagation of information. For a set of inputs to the perceptron, weights (and biases to shift weights) can be assigned. These inputs and weights can be multiplied out correspondingly together to obtain a sum output. Those skilled in the art may recognize tools such as, but not limited to, PyTorch, Tensorflow, and MXNet as training packages for common neural network tasks. However, it is contemplated that other tools may be developed specifically for the neural network tasks related to the embodiments described herein.

In many embodiments, weight matrices of the neural network 500 can be initialized randomly or obtained from a pre-trained model. These weight matrices can be multiplied with the input matrix (or output from a previous layer) and subjected to a nonlinear activation function to yield updated representations, which are often referred to as activations or feature maps. A loss function (also known as an objective function or empirical risk) can often be calculated by comparing the output of the neural network 500 and known target value data.

Feedforward networks, such as the neural network 500 depicted in the embodiment of FIG. 5, are often configured as neural networks where information moves in one direction, from the input layer 510 through the hidden layers 520 to the output layer 530, without any cycles or loops. The feedforward networks are primarily utilized for tasks such as classification, regression, and simple pattern recognition, where each input is processed independently of others. In contrast, backpropagation is not a separate type of network but rather a training algorithm commonly utilized in both feedforward and other types of networks such as Recurrent Neural Networks (RNNs).

Backpropagation involves adjusting the weights of the neural network in a reverse direction (from output to input) based on an error between a predicted output and an actual target during training. While feedforward describes the structure and data flow within the neural network, backpropagation is a technique utilized to optimize the model. Feedforward networks are utilized for straightforward tasks where input-output relationships are not sequential or time-dependent. However, for problems involving learning complex patterns over time, such as speech recognition or time-series analysis, neural networks that leverage backpropagation for training such as RNNs or deep feedforward networks with many hidden layers, become necessary to capture these intricate dependencies.

Typically, in these network arrangements, the weights are iteratively updated via various methods including, but not limited to, stochastic gradient descent algorithms to help minimize the loss function until a desired accuracy is achieved. Most modern deep learning frameworks can facilitate this iterative update by using reverse-mode automatic differentiation to obtain partial derivatives of the loss function with respect to each network parameter through recursive application of a chain rule. Colloquially, this is also known as backpropagation. Common gradient descent algorithms can include, but are not limited to, Stochastic Gradient Descent (SGD), Adam, Adagrad, etc. Learning rate is one of the parameters in gradient descent. Except for SGD, all other methods utilize adaptive learning parameter tuning. Depending on the objective such as classification or regression, different loss functions such as Binary Cross Entropy (BCE), Negative Log Likelihood Loss (NLLL), or Mean Squared Error (MSE) can be utilized.

Neural network architecture is commonly utilized for a wide range of tasks in fields such as computer vision, NLP, financial forecasting, and materials science. For instance, the neural network architecture can be employed to recognize patterns in images such as identifying objects or faces, or to classify text into categories such as spam detection in emails or network traffic classification. The neural network architecture is also useful in regression problems, such as predicting stock prices or energy consumption, where input features can be processed to output continuous values. However, this is a general example of an AI model, illustrating how a feedforward neural network works. Depending on the problem, other methods and models may be more appropriate. For example, CNNs are often utilized for image processing tasks, while RNNs are suitable for sequential data such as time series data or text. Additionally, simpler models such as linear regression, decision trees, or SVMs may be sufficient if the problem is less complex, or a dataset is relatively small. The embodiment depicted in FIG. 5 is presented as an example ML solution that may be deployed within one or more methods or systems described herein.

In a number of embodiments, the input layer 510 is the first layer in the neural network 500 and serves as the initial point where raw network traffic data 550 is introduced into the model. Each node (or neuron) in this input layer 510 represents an individual feature or variable from the dataset, allowing the neural network 500 to receive and process various types of data, such as packet features in the network traffic data 550, pixel values in an image, numerical features in a spreadsheet, or words in a text document. For instance, in image recognition tasks, the input layer 510 can include nodes that correspond to pixel values of the image, providing the neural network 500 with visual information needed to identify objects or patterns. The number of nodes in the input layer 510 directly depends on the number of features present in the dataset. If there are one hundred features in the data, the input layer 510 will typically have one hundred nodes, each conveying one piece of the information to the subsequent layers. In a variety of embodiments, the inputs of the neural network 500 are generally scaled, that is, normalized to have a zero mean and/or a unit standard deviation. Scaling can also be applied to the input of the hidden layers 520, for example, by utilizing batch or layer normalization to improve the stability of the neural network 500.

Unlike the hidden layers 520 and the output layer 530, the input layer 510 typically does not perform any computations or transformations on the data. The primary function of the input layer 510 is often to pass the input data to the next layer in the neural network 500, that is, the first hidden layer 521. However, it is often desired that the data fed into this hidden layer 521 is preprocessed appropriately, such as being normalized or standardized, to ensure that the neural network 500 can learn efficiently. Proper preprocessing, for example, scaling numerical values or encoding categorical variables, can help the neural network 500 process data uniformly, facilitating more stable and faster convergence during training.

The design of the input layer 510 depends on the nature of the problem. For example, in NLP, the input layer 510 may represent words encoded as numerical vectors, while in time series analysis, each node may represent a data point in a sequence. While the input layer 510 itself does not modify the data, the input layer 510 sets the stage for the neural network 500 to extract complex patterns and relationships through the deeper layers. This flexibility in handling various types of input make the neural network 500 a powerful tool for a diverse set of applications.

With respect to the embodiments described herein, the input layer 510 may be configured with a plurality of inputs providing network traffic data 550. For example, the ML model can be configured with a first input 511 configured as packet header characteristics, a second input 512 configured with payload characteristics, while additional inputs can be added related to temporal characteristics associated with the network traffic. The nth input 515 can be configured in various embodiments to include state transition characteristics associated with the network traffic. However, as those skilled in the art will recognize, additional setups can be configured such that the inputs 511, 512, and 515 can be configured to also include different parameters such as IP addresses, one or more port numbers, packet sizes, one or more protocol types, one or more timestamps, one or more bytes of a payload, weights, etc.

In more embodiments, the neural network 500 comprises a plurality of hidden layers 520. The embodiment depicted in FIG. 5 comprises a first hidden layer 521, a second hidden layer 522, and an nth hidden layer 525, which are denoted as h₁, h₂, and hₙ, respectively. In additional embodiments, the hidden layers 520 are disposed where the core of the ML model's learning and pattern recognition occurs. In each of the hidden layers 520, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the neural network 500 to capture complex patterns in the data that simple linear models cannot. The intricate web of connections among neurons across layers helps the neural network 500 transform and process input features into representations that become progressively more abstract and useful for making predictions.

The first hidden layer 521, h₁, receives direct input from the input layer 510, transforming the raw network traffic data 550 into an initial set of features. For example, in an intrusion detection task, the first hidden layer 521 may initiate identifying patterns in basic statistical features such as flow duration, packet size, number of packets, inter-arrival times, or the like; detecting outliers or instances that deviate substantially from the rest of the training data such as unexpected protocol transitions, unusual spiles in the network traffic, unexpected state transitions in communication protocols; or the like. The output of the first hidden layer 521 is then passed to the second hidden layer 522, h₂, which builds upon the features identified by the first hidden layer 521. This deeper hidden layer 522 may start recognizing more complex patterns, such as large packet sizes with short flow durations, frequent transitions between different protocols, repeated bursts of network traffic across multiple time windows, unusual time patterns in the flow of packets, or the like, by combining the lower-level features identified in the previous hidden layer. This can continue until a last, nth hidden layer 525, hₙ, continues this abstraction process, allowing the neural network 500 to recognize even higher-level, more detailed features, such as identifying a combination of multiple protocol transitions over time that indicate a multi-stage attack, for example, Man-in-the-Middle (MitM) attacks, Advanced Persistent Threats (APTs), or the like, or understanding intricate relationships in the input network traffic data. With respect to the embodiments described herein, the hidden layers 520 may learn one or more patterns of the input network traffic to extract higher-level features from the raw network traffic data 550, thereby improving the ability of the ML model to distinguish between legitimate network traffic, corrupted network traffic, and anomalous traffic.

Each of the hidden layers 520 adds a level of complexity and abstraction to the learning capabilities of the neural network 500. The multi-layer structure can enable the neural network 500 to move from recognizing simple patterns in the first hidden layer 521 to highly complex, abstract concepts in the deeper layers. The number of hidden layers 520 and neurons within them can vary depending on the complexity of the problem. More hidden layers 520 generally allow the neural network 500 to model more intricate functions, making deep neural networks especially effective for tasks such as image recognition, NLP, anomaly detection, and complex predictive modeling. However, adding more layers also increases the computational demand and the risk of overfitting, highlighting the need to carefully design and tune these hidden layers 520 for optimal performance.

In further embodiments, the output layer 530 is often the final layer in the neural network 500 and is responsible for producing predictions or classifications of the neural network 500 based on the information processed through the previous hidden layers 520. Each neuron in the output layer 530 can represent a specific outcome or category that the ML model can predict. In the embodiment depicted in FIG. 5, the outputs are labeled as “output 1” 531 to “output n” 535, indicating that the neural network 500 can be designed to have a varying number of outputs depending on the nature of the problem being solved. For example, in a binary classification (e.g., legitimate traffic versus anomalous traffic), there would typically be a single output neuron that provides a probability score for one of the two classes/outcomes. In contrast, for multi-class classification (e.g., categorizing network traffic into different types based on protocols utilized in communications), the output layer 530 would contain multiple neurons, each corresponding to a different class.

The number of neurons in the output layer 530 can also be designed specifically for other types of tasks, such as regression, where the ML model can predict continuous values. In such cases, the output layer 530 may contain a single neuron representing a numerical prediction, such as a price of a house or a temperature forecast, etc. Alternatively, in complex applications such as multi-label classification (where each input can belong to multiple classes simultaneously), the output layer 530 could have multiple neurons, each representing a different class, with each neuron outputting a probability of the input belonging to that specific class.

The activation function utilized in the output layer 530 can vary based on the desired output. For binary classification, a sigmoid function is commonly utilized to produce a probability between 0 and 1. For multi-class classifications, a softmax function can be applied to output a set of probabilities that sum to 1, indicating the most likely class. For regression problems, a linear activation function is often utilized to output a continuous range of values. The flexibility in designing the output layer 530 allows the neural network 500 to be applied to a wide variety of tasks, from simple binary decisions to complex multi-output predictions, making them a versatile tool in artificial intelligence and machine learning.

Although a specific embodiment for an example neural network 500 suitable for carrying out the various steps, processes, methods, and operations described herein is discussed with respect to FIG. 5, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 5, which is an illustrative example meant to make it easier to explain the basic concepts of neural networks and how they process information. The specific features and functions described herein are not intended to be limiting to this specific embodiment. The elements depicted in FIG. 5 may also be interchangeable with other elements of FIGS. 1-4 and FIGS. 6-12 as required to realize a particularly desired embodiment.

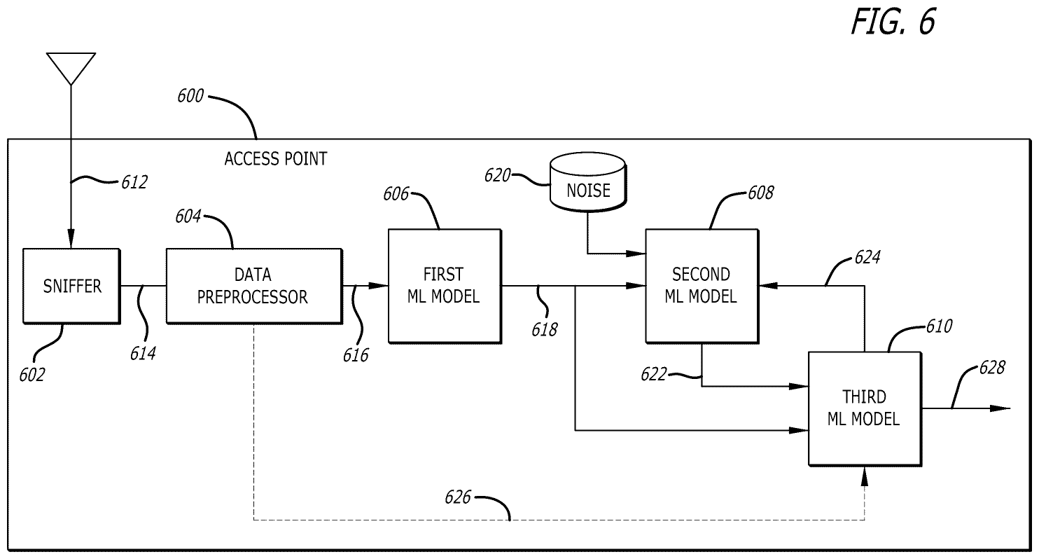

Referring to FIG. 6, a block diagram illustrating an edge-based network device configured to perform wireless intrusion detection based on deep learning in accordance with various embodiments of the disclosure is shown. In many embodiments, the edge-based network device may be an access point 600. The access point 600 may refer to a network device that allows wireless devices to connect to a wired network, for example, a Local Area Network (LAN). The access point 600 may allow the wireless devices to connect to the wired network by utilizing, for example, Wi-Fi® or other wireless technologies. The access point 600 may act as a bridge between the wireless devices and the wired network, enabling the wireless devices to access the wired network, share resources, and communicate with other devices. In a number of embodiments, as an edge-based network device, the access point 600 may be located at the edge of a network, near a source of data generation or consumption. In a variety of embodiments, the access point 600 may be responsible for processing, analyzing, or storing data locally, often without needing to transmit all the data to a central server or a cloud. The access point 600 may be configured to perform computations or data processing locally or closer to where the data originates, reducing latency, conserving bandwidth, improving security, and enabling real-time decision-making. For purposes of illustration, the detailed description may refer to the edge-based network device being the access point 600, however, the scope of the systems, devices, and methods discussed herein may not be limited to the edge-based network device being the access point 600, but may extend to the edge-based network device being any other network device, for example, a switch, a router, or the like.

In various embodiments, the access point 600 may implement a Wireless Intrusion Detection (WID) system that may utilize the processing capability of the access point 600 to analyze packet streams of wireless network traffic such as Wi-Fi® network traffic associated with a wireless network, for example, a Wi-Fi® network, and distinguish between normal behavior and anomalous behavior of the wireless network. As opposed to normal behavior, anomalous behavior may refer to any behavior that does not conform to learned states or transitions of a normal behavior state machine. Anomalous behavior may include, for example, a sudden spike in Wi-Fi network traffic from a device that typically transmits minimal network traffic, a device attempting to join the Wi-Fi network in a way that deviates from the normal behavior, strange timing or sequences such as irregular session establishment or unexpected disassociation requests. For purposes of illustration, the detailed description may refer to performing wireless intrusion detection in a Wi-Fi® network; however, the scope of the systems, devices, and methods discussed herein may not be limited to performing wireless intrusion detection in a Wi-Fi® network, but may extend to performing wireless intrusion detection in other wireless networks such as General Packet Radio Service (GPRS) networks, mobile telecommunication networks such as a Global System for Mobile (GSM) communications network, Code Division Multiple Access (CDMA) networks, Nth generation mobile communication networks, where N may include 3, 4, 5, 6, etc., and Long-Term Evolution (LTE) mobile communication networks, or the like. Wireless intrusion detection may include detection of anomalous activities, intrusion attempts, and vulnerabilities within the wireless network. Wireless intrusion detection may identify possible attacks, unauthorized access, or misconfigurations in the wireless network. The access point 600 may be configured to mitigate the susceptibility of wireless networks to a broad spectrum of cyber threats or security threats, for example, malware, system vulnerabilities, or the like, and attacks such as unauthorized access, data breaches, Denial-of-Service (DoS) attacks, or the like. The implementation of the WID system in the access point 600 for Wi-Fi networks may enhance security defenses of various applications and devices that depend on a Wi-Fi communication protocol for connectivity, thereby preserving the integrity and security of data and communication channels. In more embodiments, the access point 600 may utilize deep learning for anomaly detection-based wireless intrusion detection.

In additional embodiments, the access point 600 may be configured to implement Machine Learning (ML) techniques including deep learning to improve accuracy of detection of potential security threats and attacks including known and unknown attacks in the Wi-Fi network. By employing ML techniques, the WID system in the access point 600 may enhance the ability to identify and respond to Wi-Fi attacks, which exploit vulnerabilities in the Wi-Fi communication protocol by deviating from the normal behavior of the Wi-Fi network. In further embodiments, the WID system in the access point 600 may include a sniffer 602, a data preprocessor 604, and multiple ML models, for example, a first ML model 606, a second ML model 608, and a third ML model 610, as illustrated in FIG. 6. The terms “first,” “second,” and “third” may be utilized herein for descriptive purposes only and are not to be construed to indicate or imply relative importance. The first ML model 606, the second ML model 608, and the third ML model 610 may collectively be referred to as “the ML models 606, 608, and 610”. In still more embodiments, the ML models 606, 608, and 610 may be configured as neural network-based models that can robustly classify network traffic as legitimate network traffic, corrupted network traffic, and anomalous network traffic. The embodiments illustrated in FIG. 6 are described in the context of three ML models 606, 608, and 610 as a non-limiting example, where the first ML model 606 may be an ANN model, and the second ML model 608 and the third ML model 610 may be a generator and a discriminator corresponding to a GAN, respectively. The second ML model 608 and the third ML model 610 may herein be exemplarily referred to as “the generator 608” and “the discriminator 610,” respectively. In still further embodiments, the access point 600 may further include a noise database 620 configured to feed a random noise input into the generator 608 for facilitating generation of synthetic network traffic 622. By utilizing the GAN, the WID system in the access point 600 may discriminate between normal behavior and anomalous behavior, aiming to detect potential intrusions by identifying deviations from a pre-established baseline of normal network traffic patterns. In still additional embodiments, the WID system may implement an anomaly detection-based method, wherein deviations from the established baseline may be indicative of potential security threats.

In some more embodiments, the access point 600 may include specialized hardware or software architecture that is configured to run the ML models 606, 608, and 610 and handle specific tasks, workloads, or processing requirements efficiently, with real-time constraints, and without relying on cloud or central servers for processing. In yet various embodiments, the ML models 606, 608, and 610 may be implemented on a specific, dedicated architecture, for example, a Neural Processing Unit (NPU)/tensor structure, in the access point 600, which makes the implementation of the ML models 606, 608, and 610 easily detectable. In yet more embodiments, the ML models 606, 608, and 610 may be stored in a memory of the access point 600. In still yet more embodiments, the ML models 606, 608, and 610 may be configured as Deep Neural Network (DNN) models that can run at the edge on the access point 600, where resources of the NPU are limited, while still achieving goals of being scalable, highly accurate, and able to detect security threats and attacks, thereby being able to flag anomalous traffic. In many further embodiments, training of all the ML models 606, 608, and 610 may be executed on a single access point 600 as illustrated in the example implementation of FIG. 6.

With respect to the embodiments described herein, the sniffer 602 may be configured as a packet sniffer, a packet analyzer, or a network analyzer for monitoring, capturing, and collecting wireless network traffic, for example, Wi-Fi network traffic 612, associated with the Wi-Fi network. In many additional embodiments, the sniffer 602 may receive the Wi-Fi network traffic 612 including multiple packets of network traffic data as an input. In still yet further embodiments, the sniffer 602 may “sniff” packets being transmitted over host Network Interface Cards (NIC) of the wireless devices. The sniffer 602 may listen to wireless communications on the Wi-Fi network and collect the packets transmitted between the wireless devices. These packets may include, for example, control messages, data transmissions, and network traffic patterns. The sniffer 602 may access and read all packets transmitted to and from the access point 600. The sniffer 602 may transmit the Wi-Fi network traffic 612 to the data preprocessor 604 as a real-time or near-real-time Wi-Fi network traffic stream 614 including a sequence of the collected packets.

To develop an accurate model of normal Wi-Fi communication protocol behavior, the data preprocessor 604 may pre-process raw Wi-Fi network traffic data associated with the Wi-Fi network traffic stream 614 output by the sniffer 602. The raw Wi-Fi network traffic data may relate, for example, to a packet, a collection of packets, a flow, a group of flows, or the like. The data preprocessor 604 may receive the Wi-Fi network traffic stream 614 from the sniffer 602 and execute preprocessing of the associated Wi-Fi network traffic data into a format suitable for the first ML model 606. In still yet additional embodiments, preprocessing may include data cleaning, for example, by handling missing packets, corrupted packet data, or fields with null values, removing duplicate packets, and filtering irrelevant or noisy network traffic data such as non-data frames, control frames, or broadcast traffic that may not be useful for feature extraction. In several embodiments, preprocessing may further include scaling, for example, min-max scaling of values between a specific range such as 0 to 1; standardization that may include transforming features to have a mean of 0 and a standard deviation of 1; feature scaling ensuring packet size, inter-arrival time, and other packet features contribute equally to the first ML model 606; or the like. In several more embodiments, preprocessing may further include encoding categorical values, for example, protocol types, flags, source addresses, destination addresses, port numbers, or like, into numerical values by utilizing techniques such as one-hot encoding, label encoding, or the like.

In numerous embodiments, preprocessing may further include aggregating the Wi-Fi network traffic data over time windows to group data in manageable chunks, timestamp processing by computing time-based features, for example, packet arrival times, inter-arrival times, and session durations. In numerous additional embodiments, preprocessing may further include data augmentation such as summarizing packet statistics, for example, average packet size, total traffic volume in a time window, noise filtering, or the like. In further additional embodiments, preprocessing may further include segmentation where the continuous Wi-Fi network traffic stream 614 may be broken down into sessions or flows based on network behaviors such as a Transmission Control Protocol (TCP) handshake or connection initiation and/or termination. In many embodiments, preprocessing may further include flow aggregation where the Wi-Fi network traffic stream 614 can be grouped into flows, for example, based on Internet Protocol (IP) address pairs, ports, or protocol types. After preprocessing, the data preprocessor 604 may transmit the preprocessed Wi-Fi network traffic data 616 to the first ML model 606.

In a number of embodiments, by analyzing state transitions within the Wi-Fi network traffic data 616, the first ML model 606 may construct a normal behavior state machine 618, encapsulating a typical operation of the Wi-Fi communication protocol. In a variety of embodiments, the first ML model 606 may utilize an ANN for constructing the normal behavior state machine 618. The normal behavior state machine 618 may refer to a model or a representation of a typical behavior of the Wi-Fi network under normal, non-malicious conditions. The first ML model 606 may construct the normal behavior state machine 618 after learning normal network traffic patterns of communication, traffic flows, and interactions between devices in the Wi-Fi network. The normal behavior state machine 618 may be utilized for tracking the current operational state of the Wi-Fi network, and may assist in identifying any deviations from normal behavior, which may indicate anomalies or intrusions. In various embodiments, the first ML model 606 may construct separate normal behavior state machines for different types of features, for example, time-based features such as latency, arrival time, or the like, size-based features such as packet length, and sequence flow features.

The normal behavior state machine 618 may include normal states representing various normal conditions or phases of operation within the Wi-Fi network. These normal states may include behaviors, for example, idle states indicative of periods with low or no network traffic, active states indicative of regular network activity with normal traffic volumes, high traffic states indicative of an occurrence of large file transfers or bandwidth-intensive tasks, connection states indicative of phases where devices are joining or leaving the Wi-Fi network, such as authentication and association states. By utilizing the ANN, the first ML model 606 may learn these normal states by analyzing the Wi-Fi network traffic data 616 over time and recognizing recurring network traffic patterns. For example, if a device frequently communicates using specific packet sizes, protocols, or frequencies, the first ML model 606 may learn this communication pattern as a normal network traffic pattern. The first ML model 606 may observe the Wi-Fi network traffic data 616 for sufficient periods and extract features from the Wi-Fi network traffic data 616. The features may include, for example, header characteristics, payload characteristics, temporal characteristics such as temporal patterns in packet arrivals, or state transition characteristics associated with legitimate network traffic. The features may further include, for example, packet size distribution, transmission intervals, communication frequency, protocol usage, number of active connections, signal strength, network traffic volume, connection states such association, disassociation, or authentication, or the like. The features may further include, for example, session duration, packet inter-arrival time, traffic flow characteristics, frequency of protocol exchanges such as Domain Name Server (DNS) or Address Resolution Protocol (ARP) requests, request and response patterns to identify normal network traffic patterns between clients and the access point 600, or the like. By extracting these informative features, the dimensionality of the Wi-Fi network traffic data 616 may be reduced, thereby facilitating more efficient learning by the subsequent ML models, for example, the second ML model 608 and the third ML model 610. The extracted features may capture underlying network behavior. The first ML model 606 may utilize the extracted features to classify or map Wi-Fi network traffic from the Wi-Fi network traffic data 616 into different states that represent normal behaviors of the Wi-Fi network during periods of normal operation.

The first ML model 606 may be trained on the normal network traffic patterns to construct a model of the normal behavior. In more embodiments, the training process may include presenting the ANN with a series of labeled input-output pairs, where the input may include the extracted features from the Wi-Fi network traffic data 616, and the output may include the corresponding behavior or class, that is, normal behavior. During training, the ANN may adjust its internal weights to minimize the error between its predicted output and the expected output. Common types of ANNs used for this adjustment task may include, for example, feedforward neural networks or RNNs, depending on whether the first ML model 606 may need to consider temporal dependencies in the Wi-Fi network traffic data 616 for detecting normal network traffic patterns over time. In a supervised learning setup, for example, the first ML model 606 may be trained to recognize sequences of packets or events that characterize normal behavior and map them to a “normal state”. As the first ML model 606 is trained, the first ML model 606 may learn to map the extracted features to a set of internal states, where each state may represent a certain behavior or condition in the network. For example, if the Wi-Fi network traffic data 616 exhibits consistent patterns such as regular association requests followed by a stable flow of data between devices, the Wi-Fi network may be in a “normal operational state.” The states the first ML model 606 may learn to recognize correspond to normal states of the behavior of the Wi-Fi network, forming the normal behavior state machine 618.

In additional embodiments, the normal behavior state machine 618 may model how the Wi-Fi network transitions between the different states. For example, when a device joins the Wi-Fi network, there may be a transition from an idle state to an active communication state. Similarly, if there is a burst of traffic, for example, during a file transfer, the normal behavior state machine 618 may transition into a high traffic state. The state transitions may reflect a typical flow of activities in the Wi-Fi network. In further embodiments, the first ML model 606 may learn the timing, order, and conditions under which these state transitions occur from historical Wi-Fi network traffic data.

In still more embodiments, the constructed normal behavior state machine 618 may be utilized for training the GAN. In the embodiments described herein, the GAN may include two neural networks, for example, the generator 608 and the discriminator 610, configured to generate new Wi-Fi network traffic data by learning from existing Wi-Fi network traffic data distributions in the normal behavior state machine 618. In the context of the normal behavior state machine 618 that maps Wi-Fi network traffic into different states representing normal behaviors of the Wi-Fi network, the GAN can be utilized to model and simulate these states, learn normal behavior patterns, and assist in detecting anomalies. The generator 608 and the discriminator 610 may operate together in an adversarial manner to generate realistic outputs and differentiate between real Wi-Fi network traffic and fake or intruded Wi-Fi network traffic. The real Wi-Fi network traffic may be obtained from the normal behavior state machine 618 associated with the actual Wi-Fi network. The generator 608 may receive random noise or latent variables from the noise database 620 as input and attempt to generate Wi-Fi network traffic data or patterns that mimic the real Wi-Fi network traffic, specifically, the normal behaviors learned from the normal behavior state machine 618. The discriminator 610 may be tasked with differentiating between the real Wi-Fi network traffic and the fake Wi-Fi network traffic generated by the generator 608. The discriminator 610 may learn to classify the Wi-Fi network traffic data as either real associated with normal behavior or fake generated by the generator 608. The real Wi-Fi network traffic may herein be referred to as “legitimate network traffic,” and the fake Wi-Fi network traffic may herein be referred to as “synthetic network traffic 622.” In still further embodiments, challenging frames instead of easily recognizable frames may be injected into the GAN for identifying weaknesses in the GAN's recognition capabilities. The GAN may be retrained on weak frame families until performance is consistent. The training may aim for flat recognition performance across all frame types to prevent attackers from exploiting gaps in performance. In still additional embodiments, a Large Language Model (LLM) may be utilized as the generator 608 in the GAN, which may treat frames as sentences in a language. In some more embodiments, instead of utilizing the LLM that operates on a substantial number of parameters and therefore cannot be run on the edge-based network device, the GAN may be configured as a low resource-intensive language model including parts of the LLM customized for processing the network traffic, for example, zero-day application traffic, on the edge-based network device.

In yet various embodiments, the first ML model 606 may feed the constructed normal behavior state machine 618 to the generator 608 and the discriminator 610 of the GAN. The generator 608 may learn to generate synthetic network traffic samples that mimic normal Wi-Fi network traffic patterns, while the discriminator 610 may learn to distinguish between legitimate network traffic samples and synthetic network traffic samples. Through adversarial training, the GAN may iteratively refine its ability to differentiate between the normal behavior and the anomalous behavior of the Wi-Fi network, thereby capturing complex distributions inherent in the Wi-Fi network traffic.

During training of the GAN, both the generator 608 and the discriminator 610 may be updated iteratively to improve their performance. The generator 608 may attempt to generate the synthetic network traffic 622 that resembles normal behavior of the Wi-Fi network. The generator 608 may attempt to generate new network traffic patterns that map to the normal states of the Wi-Fi network. In yet more embodiments, the generator 608 may be configured for specific types of network traffic or Quality-of-Service (QoS) levels. The discriminator 610 may evaluate whether the generated synthetic network traffic 622 matches the normal behavior of the Wi-Fi network, that is, whether the generated synthetic network traffic 622 represents the legitimate network traffic. The generator 608 and the discriminator 610 jointly operate together, where the generator 608 may improve its ability to generate legitimate network traffic, and the discriminator 610 may improve its ability to distinguish between the legitimate network traffic and the synthetic network traffic 622. Over time, this joint operation of the generator 608 and the discriminator 610 may assist the generator 608 in generating highly realistic, legitimate network traffic that mimics the normal behavior of the Wi-Fi network. The training phase of the GAN may rely on a large set of exchanges between the generator 608 and the discriminator 610. When such exchanges happen, the developed model efficiency may rely on a feedback loop 624 between the generator 608 and the discriminator 610. Because one depends on the other, the generator 608 may generate new samples based on feedback that the previous samples were flagged by the discriminator 610 as deviating from the established baseline, and the discriminator 610 may flag deviations only based on new samples generated by the generator 608.

The trained GAN may be utilized for anomaly detection in the Wi-Fi network. If a new Wi-Fi network traffic pattern is generated or observed in the Wi-Fi network, the discriminator 610 can be utilized for determining whether the new Wi-Fi network traffic pattern matches a normal pattern learned by the first ML model 606 and the GAN. For example, during implementation, the sniffer 602 may monitor and transmit the real-time Wi-Fi network traffic stream 614 to the data preprocessor 604. The data preprocessor 604 may pre-process the real-time Wi-Fi network traffic stream 614 as disclosed above and transmit the preprocessed network traffic data 626 to the discriminator 610 of the trained GAN. The discriminator 610 may determine whether a new Wi-Fi network traffic pattern in the preprocessed network traffic data 626 matches a normal pattern learned by the first ML model 606 and the GAN. If the discriminator 610 identifies the new Wi-Fi network traffic pattern as “fake” or abnormal, the discriminator 610 may indicate that the behavior of the Wi-Fi network deviates from a normal state. If the new Wi-Fi network traffic pattern deviates substantially from the normal state or violates expected state transitions, the discriminator 610 may flag the new Wi-Fi network traffic pattern as anomalous in its output 628. In an example, if the generator 608 generates Wi-Fi network traffic representing normal conditions, but the discriminator 610 flags the real-world new Wi-Fi network traffic as abnormal, the WID system in the access point 600 may trigger an alert for network anomalies such as a security breach, traffic congestion, or unexpected behavior. In a further example, an unexpected, sudden surge of Wi-Fi network traffic such as a DOS attack could cause the normal behavior state machine 618 to shift from a normal state to a high traffic anomaly state, which may be a deviation from the learned pattern of normal network usage, based on which the discriminator 610 flags the Wi-Fi network traffic as abnormal, causing the WID system in the access point 600 may trigger an alert for the DoS attack. In a further example, a state transition from a normal state to a de-authentication attack state or a packet injection state may signal an anomaly, indicating that an attack may be occurring.

In a further example, a normal high traffic state followed by an unexpected drop in Wi-Fi network traffic may suggest a problem with the Wi-Fi network, such as a malfunctioning device or an intrusion event. The intrusion event may refer to any occurrence in the Wi-Fi network where the network traffic or behavior does not align with the normal states established by the normal behavior state machine 618, suggesting a potential security breach or network anomaly. The intrusion event may indicate an attack, for example, a DoS attack, unauthorized device access, or a malicious activity such as packet sniffing or data interception. By leveraging ML techniques, the WID system may improve the anomaly detection accuracy of potential security threats in Wi-Fi networks, including known and new or unknown attacks. The use of the GAN may allow the WID system to adapt to evolving security threats, attack techniques, and network dynamics, ensuring robust intrusion detection capabilities over time. Further, in still yet more embodiments, the WID system may detect intrusion events from the Wi-Fi network traffic locally on the access point 600 without having to transmit the packets constituting the Wi-Fi network traffic to another entity such as the cloud or a controller.

Further, in many further embodiments, to address the challenge of high false alarms associated with the anomaly-based WID system, the systems, devices, and methods discussed herein may implement techniques for anomaly score aggregation and thresholding. In many additional embodiments, after the GAN-based anomaly detection phase, the WID system may compute anomaly scores for each observed data point, indicating a likelihood of deviation from normal behavior. The WID system may then aggregate these anomaly scores over time windows and compare the anomaly scores against predefined thresholds to determine the presence of an intrusion event. By employing adaptive thresholding mechanisms and incorporating feedback from network administrators, the WID system can dynamically adjust its sensitivity to balance false alarm rates with anomaly detection accuracy. Through anomaly score aggregation and thresholding mechanisms, the WID system may mitigate false alarms, minimizing disruptions to network operations and reducing the burden on the network administrators.

Although a specific embodiment for an edge-based network device configured to perform wireless intrusion detection based on deep learning suitable for carrying out the various steps, processes, methods, and operations described herein is discussed with respect to FIG. 6, any of a variety of systems and/or processes may be utilized in accordance with embodiments of the disclosure. For example, instead of the GAN, other neural networks and mechanisms such as transformers with one or more attention layers for capturing and generalizing from complex network traffic patterns and dynamically focusing on the most relevant parts of the network traffic data when making classification decisions related to new or unusual features in zero-day application traffic, can be utilized in the access point 600 for detecting intrusion events based on deep learning. The elements depicted in FIG. 6 may also be interchangeable with other elements of FIGS. 1-5 and FIGS. 7-12 as required to realize a particularly desired embodiment.

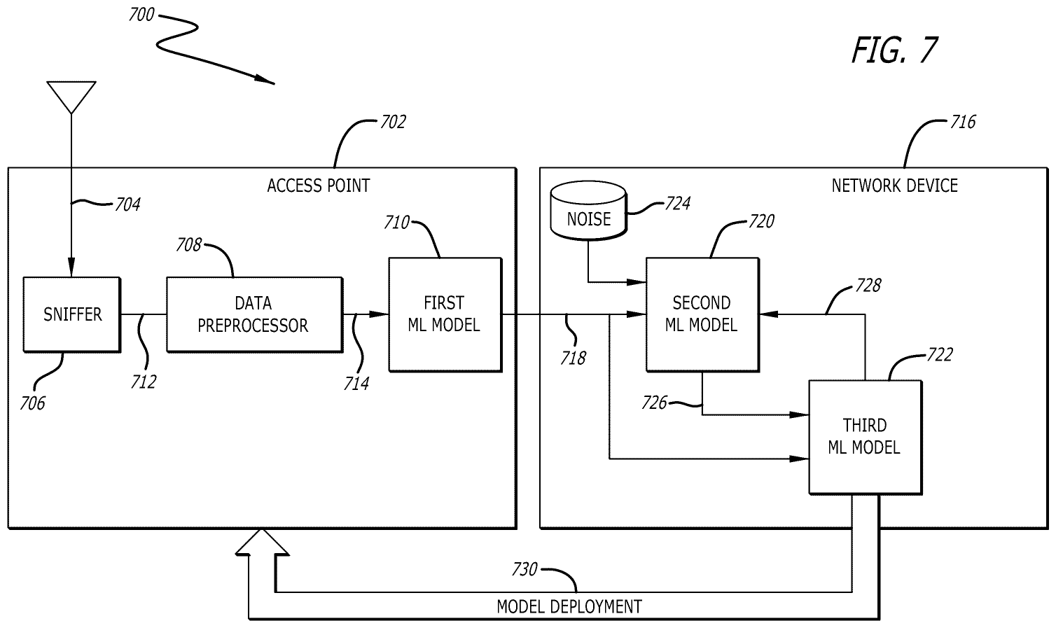

Referring to FIG. 7, a block diagram illustrating a WID system 700 in accordance with various embodiments of the disclosure is shown. In an example implementation illustrated in FIG. 7, the WID system 700 may include multiple edge-based network devices configured to perform wireless intrusion detection based on deep learning. In many embodiments, the edge-based network devices may include an access point 702 configured to implement a first ML model 710 and another network device 716 configured to implement a second ML model 720 and a third ML model 722 as illustrated in FIG. 7. In a number of embodiments, training of the first ML model 710 may be executed on the access point 702, while training of the second ML model 720 and the third ML model 722 may be executed on the network device 716 as illustrated in the example implementation of FIG. 7. The first ML model 710, the second ML model 720, and the third ML model 722 may collectively be referred to as “the ML models 710, 720, and 722”. The embodiments illustrated in FIG. 7 are described in the context of three ML models 710, 720, and 722 as a non-limiting example. For purposes of illustration, the detailed description may refer to one of the edge-based network devices being the access point 702, however, the scope of the systems, devices, and methods discussed herein may not be limited to the edge-based network device being the access point 702, but may extend to the edge-based network device being any other network device, for example, a switch, a router, or the like. The other network device 716 may be another access point, switch, or router. In a variety of embodiments, as edge-based network devices, the access point 702 and the network device 716 may be located at the edge of a network, near a source of data generation or consumption.

In various embodiments, the WID system 700 may utilize processing capabilities of the access point 702 and the network device 716 to analyze packet streams of wireless network traffic such as Wi-Fi® network traffic associated with a wireless network, for example, a Wi-Fi® network, and distinguish between normal behavior and anomalous behavior of the wireless network. The WID system 700 may be configured to mitigate the susceptibility of wireless networks to a broad spectrum of cyber threats or security threats, for example, malware, system vulnerabilities, or the like, and attacks such as unauthorized access, data breaches, Denial-of-Service (DoS) attacks, or the like. The implementation of the WID system 700 for Wi-Fi networks may enhance security defenses of various applications and devices that depend on a Wi-Fi communication protocol for connectivity, thereby preserving the integrity and security of data and communication channels. In more embodiments, the WID system 700 may utilize deep learning for anomaly detection-based wireless intrusion detection. In further embodiments, the WID system 700 may be configured to implement ML techniques including deep learning to improve accuracy of detection of potential security threats and attacks including known and unknown attacks in the Wi-Fi network. By employing ML techniques, the WID system 700 may enhance the ability to identify and respond to Wi-Fi attacks, which exploit vulnerabilities in the Wi-Fi communication protocol by deviating from the normal behavior of the Wi-Fi network.

The access point 702 may refer to a network device that allows wireless devices to connect to a wired network, for example, a Local Area Network (LAN), by utilizing, for example, Wi-Fi® or other wireless technologies. In additional embodiments, the access point 702 may be responsible for processing, analyzing, or storing data locally, often without needing to transmit all the data to a central server or a cloud. The access point 702 may be configured to perform computations or data processing locally or closer to where the data originates, reducing latency, conserving bandwidth, improving security, and enabling real-time decision-making. In further embodiments, the access point 702 may include a sniffer 706, a data preprocessor 708, and the first ML model 710 as illustrated in the example implementation of the WID system 700 shown in FIG. 7. In still more embodiments, the first ML model 710 may be configured as a neural network-based model to construct a normal behavior state machine 718. In still further embodiments, the first ML model 710 may be an ANN model. In still additional embodiments, the access point 702 may include specialized hardware or software architecture that is configured to run the first ML model 710 and handle specific tasks, workloads, or processing requirements efficiently, with real-time constraints, and without relying on cloud or central servers for processing. In some more embodiments, the first ML model 710 may be implemented on a specific, dedicated architecture, for example, a Neural Processing Unit (NPU)/tensor structure, in the access point 702, which makes the implementation of the first ML model 710 easily detectable. In yet various embodiments, the first ML model 710 may be stored in a memory of the access point 702. In yet more embodiments, the first ML model 710 may be configured as a Deep Neural Network (DNN) model that can run at the edge on the access point 702, where resources of the NPU are limited, while still achieving goals of being scalable, highly accurate, and able to detect security threats and attacks, thereby being able to flag anomalous traffic.

With respect to the embodiments described herein, the sniffer 706 may be configured as a packet sniffer, a packet analyzer, or a network analyzer for monitoring, capturing, and collecting wireless network traffic, for example, Wi-Fi network traffic 704, associated with the Wi-Fi network. In still yet more embodiments, the sniffer 706 may receive the Wi-Fi network traffic 704 including multiple packets of network traffic data as an input. In many further embodiments, the sniffer 706 may “sniff” packets being transmitted over host Network Interface Cards (NIC) of the wireless devices. The sniffer 706 may listen to wireless communications on the Wi-Fi network and collect the packets transmitted between the wireless devices. These packets may include, for example, control messages, data transmissions, and network traffic patterns. The sniffer 706 may access and read all packets transmitted to and from the access point 702. The sniffer 706 may transmit the Wi-Fi network traffic 704 to the data preprocessor 708 as a real-time or near-real-time Wi-Fi network traffic stream 712 including a sequence of the collected packets.

To develop an accurate model of normal Wi-Fi communication protocol behavior, the data preprocessor 708 may pre-process raw Wi-Fi network traffic data associated with the Wi-Fi network traffic stream 712 output by the sniffer 706. The raw Wi-Fi network traffic data may relate, for example, to a packet, a collection of packets, a flow, a group of flows, or the like. The data preprocessor 708 may receive the Wi-Fi network traffic stream 712 from the sniffer 706 and execute preprocessing of the associated Wi-Fi network traffic data into a format suitable for the first ML model 710. In many additional embodiments, preprocessing may include data cleaning, for example, by handling missing packets, corrupted packet data, or fields with null values, removing duplicate packets, and filtering irrelevant or noisy network traffic data such as non-data frames, control frames, or broadcast traffic that may not be useful for feature extraction. In still yet further embodiments, preprocessing may further include scaling, for example, min-max scaling of values between a specific range such as 0 to 1; standardization that may include transforming features to have a mean of 0 and a standard deviation of 1; feature scaling ensuring packet size, inter-arrival time, and other packet features contribute equally to the first ML model 710; or the like. In still yet additional embodiments, preprocessing may further include encoding categorical values, for example, protocol types, flags, source addresses, destination addresses, port numbers, or like, into numerical values by utilizing techniques such as one-hot encoding, label encoding, or the like.

In several embodiments, preprocessing may further include aggregating the Wi-Fi network traffic data over time windows to group data in manageable chunks, timestamp processing by computing time-based features, for example, packet arrival times, inter-arrival times, and session durations. In several more embodiments, preprocessing may further include data augmentation such as summarizing packet statistics, for example, average packet size, total traffic volume in a time window, noise filtering, or the like. In numerous embodiments, preprocessing may further include segmentation where the continuous Wi-Fi network traffic stream 712 may be broken down into sessions or flows based on network behaviors such as a TCP handshake or connection initiation and/or termination. In numerous additional embodiments, preprocessing may further include flow aggregation where the Wi-Fi network traffic stream 712 can be grouped into flows, for example, based on Internet Protocol (IP) address pairs, ports, or protocol types. After preprocessing, the data preprocessor 708 may transmit the preprocessed Wi-Fi network traffic data 714 to the first ML model 710.

In further additional embodiments, by analyzing state transitions within the preprocessed Wi-Fi network traffic data 714, the first ML model 710 may construct a normal behavior state machine 718, encapsulating a typical operation of the Wi-Fi communication protocol. In many embodiments, the first ML model 710 may utilize an ANN for constructing the normal behavior state machine 718. The first ML model 710 may construct the normal behavior state machine 718 after learning normal network traffic patterns of communication, traffic flows, and interactions between devices in the Wi-Fi network. The normal behavior state machine 718 may be utilized for tracking the current operational state of the Wi-Fi network, and may assist in identifying any deviations from normal behavior, which may indicate anomalies or intrusions.

The normal behavior state machine 718 may include normal states representing various normal conditions or phases of operation within the Wi-Fi network. These normal states may include behaviors, for example, idle states indicative of periods with low or no network traffic, active states indicative of regular network activity with normal traffic volumes, high traffic states indicative of an occurrence of large file transfers or bandwidth-intensive tasks, connection states indicative of phases where devices are joining or leaving the Wi-Fi network, such as authentication and association states. By utilizing the ANN, the first ML model 710 may learn these normal states by analyzing the preprocessed Wi-Fi network traffic data 714 over time and recognizing recurring network traffic patterns. For example, if a device frequently communicates using specific packet sizes, protocols, or frequencies, the first ML model 710 may learn this communication pattern as a normal network traffic pattern. The first ML model 710 may observe the preprocessed Wi-Fi network traffic data 714 for sufficient periods and extract features from the preprocessed Wi-Fi network traffic data 714. The features may include, for example, header characteristics, payload characteristics, temporal characteristics such as temporal patterns in packet arrivals, or state transition characteristics associated with legitimate network traffic. The features may further include, for example, packet size distribution, transmission intervals, communication frequency, protocol usage, number of active connections, signal strength, network traffic volume, connection states such association, disassociation, or authentication, or the like. The features may further include, for example, session duration, packet inter-arrival time, traffic flow characteristics, frequency of protocol exchanges such as DNS or ARP requests, request and response patterns to identify normal network traffic patterns between clients and the access point 702, or the like. By extracting these informative features, the dimensionality of the preprocessed Wi-Fi network traffic data 714 may be reduced, thereby facilitating more efficient learning by the subsequent ML models, for example, the second ML model 720 and the third ML model 722 deployed on the network device 716. The extracted features may capture underlying network behavior. The first ML model 710 may utilize the extracted features to classify or map Wi-Fi network traffic from the preprocessed Wi-Fi network traffic data 714 into different states that represent normal behaviors of the Wi-Fi network during periods of normal operation.

The first ML model 710 may be trained on the normal network traffic patterns to construct a model of the normal behavior. In a number of embodiments, the training process may include presenting the ANN with a series of labeled input-output pairs, where the input may include the extracted features from the preprocessed Wi-Fi network traffic data 714, and the output may include the corresponding behavior or class, that is, normal behavior. During training, the ANN may adjust its internal weights to minimize the error between its predicted output and the expected output. Common types of ANNs used for this adjustment task may include, for example, feedforward neural networks or RNNs, depending on whether the first ML model 710 may need to consider temporal dependencies in the preprocessed Wi-Fi network traffic data 714 for detecting normal network traffic patterns over time. In a supervised learning setup, for example, the first ML model 710 may be trained to recognize sequences of packets or events that characterize normal behavior and map them to a “normal state”. As the first ML model 710 is trained, the first ML model 710 may learn to map the extracted features to a set of internal states, where each state may represent a certain behavior or condition in the network. For example, if the preprocessed Wi-Fi network traffic data 714 exhibits consistent patterns such as regular association requests followed by a stable flow of data between devices, the Wi-Fi network may be in a “normal operational state.” The states the first ML model 710 may learn to recognize correspond to normal states of the behavior of the Wi-Fi network, forming the normal behavior state machine 718.

In a variety of embodiments, the normal behavior state machine 718 may model how the Wi-Fi network transitions between the different states. For example, when a device joins the Wi-Fi network, there may be a transition from an idle state to an active communication state. Similarly, if there is a burst of traffic, for example, during a file transfer, the normal behavior state machine 718 may transition into a high traffic state. The state transitions may reflect a typical flow of activities in the Wi-Fi network. In various embodiments, the first ML model 710 may learn the timing, order, and conditions under which these state transitions occur from historical Wi-Fi network traffic data.

In more embodiments, the access point 702 may transmit the constructed normal behavior state machine 718 to the network device 716 via a communication network for training subsequent ML models, that is, the second ML model 720 and the third ML model 722, deployed on the network device 716. In additional embodiments, the second ML model 720 and the third ML model 722 may be configured as neural network-based models and in communication with the first ML model 710 may be configured to robustly classify network traffic as legitimate network traffic, corrupted network traffic, and anomalous network traffic. In further embodiments, the second ML model 720 and the third ML model 722 may be two neural networks, for example, a generator and a discriminator corresponding to a GAN, respectively. The second ML model 720 and the third ML model 722 may herein be exemplarily referred to as “the generator 720” and “the discriminator 722,” respectively. In still more embodiments, the network device 716 may further include a noise database 724 configured to feed a random noise input into the generator 720 for facilitating generation of synthetic network traffic 726. By utilizing the GAN, the WID system 700 may discriminate between normal behavior and anomalous behavior, aiming to detect potential intrusions by identifying deviations from a pre-established baseline of normal network traffic patterns. In still further embodiments, the WID system 700 may implement an anomaly detection-based method, wherein deviations from the established baseline may be indicative of potential security threats.

In still additional embodiments, the network device 716 may include specialized hardware or software architecture that is configured to run the generator 720 and the discriminator 722 of the GAN and handle specific tasks, workloads, or processing requirements efficiently, with real-time constraints, and without relying on cloud or central servers for processing. In some more embodiments, the generator 720 and the discriminator 722 may be implemented on a specific, dedicated architecture, for example, an NPU/tensor structure, in the network device 716, which makes the implementation of the generator 720 and the discriminator 722 easily detectable. In yet various embodiments, the generator 720, the discriminator 722, and the noise database 724 may be stored in a memory of the network device 716. In yet more embodiments, the generator 720 and the discriminator 722 may be configured as DNN models that can run at the edge on the network device 716, where resources of the NPU are limited, while still achieving goals of being scalable, highly accurate, and able to detect security threats and attacks, thereby being able to flag anomalous traffic.

In the embodiments described herein, the GAN including the generator 720 and the discriminator 722 may be configured to generate new Wi-Fi network traffic data by learning from existing Wi-Fi network traffic data distributions in the normal behavior state machine 718. In the context of the normal behavior state machine 718 that maps Wi-Fi network traffic into different states representing normal behaviors of the Wi-Fi network, the GAN can be utilized to model and simulate these states, learn normal behavior patterns, and assist in detecting anomalies. The generator 720 and the discriminator 722 may operate together in an adversarial manner to generate realistic outputs and differentiate between real Wi-Fi network traffic and fake or intruded Wi-Fi network traffic. The real Wi-Fi network traffic may be obtained from the normal behavior state machine 718 associated with the actual Wi-Fi network. The generator 720 may receive random noise or latent variables from the noise database 724 as input and attempt to generate Wi-Fi network traffic data or patterns that mimic the real Wi-Fi network traffic, specifically the normal behaviors learned from the normal behavior state machine 718. The discriminator 722 may be tasked with differentiating between the real Wi-Fi network traffic and the fake Wi-Fi network traffic generated by the generator 720. The discriminator 722 may learn to classify the Wi-Fi network traffic data as either real associated with normal behavior or fake generated by the generator 720. The real Wi-Fi network traffic may herein be referred to as “legitimate network traffic,” and the fake Wi-Fi network traffic may herein be referred to as “synthetic network traffic 726.” In still yet more embodiments, the generator 720 may learn to generate synthetic network traffic samples that mimic normal Wi-Fi network traffic patterns, while the discriminator 722 may learn to distinguish between legitimate network traffic samples and synthetic network traffic samples. Through adversarial training, the GAN may iteratively refine its ability to differentiate between the normal behavior and the anomalous behavior of the Wi-Fi network, thereby capturing complex distributions inherent in the Wi-Fi network traffic.

During training of the GAN, both the generator 720 and the discriminator 722 may be updated iteratively to improve their performance. The generator 720 may attempt to generate synthetic network traffic 726 that resembles normal behavior of the Wi-Fi network. The generator 720 may attempt to generate new network traffic patterns that map to the normal states of the Wi-Fi network. The discriminator 722 may evaluate whether the generated synthetic network traffic 726 matches the normal behavior of the Wi-Fi network, that is, whether the generated synthetic network traffic 726 represents the legitimate network traffic. The generator 720 and the discriminator 722 jointly operate together, where the generator 720 may improve its ability to generate legitimate network traffic, and the discriminator 722 may improve its ability to distinguish between the legitimate network traffic and the synthetic network traffic 726. Over time, this joint operation of the generator 720 and the discriminator 722 may assist the generator 720 in generating highly realistic, legitimate network traffic that mimics the normal behavior of the Wi-Fi network. The training phase of the GAN may rely on a large set of exchanges between the generator 720 and the discriminator 722. When such exchanges happen, the developed model efficiency may rely on a feedback loop 728 between the generator 720 and the discriminator 722. Because one depends on the other, the generator 720 may generate new samples based on feedback that the previous samples were flagged by the discriminator 722 as deviating from the established baseline, and the discriminator 722 may flag deviations only based on new samples generated by the generator 720. In many further embodiments, the GAN that is trained in the network device 716 may be deployed on the access point 702 as indicated by an arrow 730 as illustrated in FIG. 7.

The trained GAN may be utilized for anomaly detection in the Wi-Fi network. If a new Wi-Fi network traffic pattern is generated or observed in the Wi-Fi network, the discriminator 722 can be utilized for determining whether the new Wi-Fi network traffic pattern matches a normal pattern learned by the first ML model 710 and the GAN. For example, during implementation, the sniffer 706 may monitor and transmit the real-time Wi-Fi network traffic stream 712 to the data preprocessor 708. The data preprocessor 708 may pre-process the real-time Wi-Fi network traffic stream 712 as disclosed above and transmit the preprocessed Wi-Fi network traffic data 714 to the discriminator 722 of the trained GAN. The discriminator 722 may determine whether a new Wi-Fi network traffic pattern in the preprocessed Wi-Fi network traffic data 714 matches a normal pattern learned by the first ML model 710 and the GAN. If the discriminator 722 identifies the new Wi-Fi network traffic pattern as “fake” or abnormal, the discriminator 722 may indicate that the behavior of the Wi-Fi network deviates from a normal state. If the new Wi-Fi network traffic pattern deviates substantially from the normal state or violates expected state transitions, the discriminator 722 may flag the new Wi-Fi network traffic pattern as anomalous in its output. In an example, if the generator 720 generates Wi-Fi network traffic representing normal conditions, but the discriminator 722 flags the real-world new Wi-Fi network traffic as abnormal, the WID system in the access point 702 may trigger an alert for network anomalies such as a security breach, traffic congestion, or unexpected behavior. In a further example, an unexpected, sudden surge of Wi-Fi network traffic such as a DoS attack could cause the normal behavior state machine 718 to shift from a normal state to a high traffic anomaly state, which may be a deviation from the learned pattern of normal network usage, based on which the discriminator 722 flags the Wi-Fi network traffic as abnormal, causing the WID system 700 to trigger an alert for the DoS attack.

In a further example, a normal high traffic state followed by an unexpected drop in Wi-Fi network traffic may suggest a problem with the Wi-Fi network, such as a malfunctioning device or an intrusion event. By leveraging ML techniques, the WID system 700 may improve the anomaly detection accuracy of potential security threats in Wi-Fi networks, including known and new or unknown attacks. The use of the GAN may allow the WID system 700 to adapt to evolving security threats, attack techniques, and network dynamics, ensuring robust intrusion detection capabilities over time. Further, in many additional embodiments, the WID system 700 may detect intrusion events from the Wi-Fi network traffic on the access point 702 and the network device 716 without having to transmit the packets constituting the Wi-Fi network traffic to another entity such as the cloud or a controller.

In still yet further embodiments, after the GAN-based anomaly detection phase, the WID system 700 may compute anomaly scores for each observed data point, indicating a likelihood of deviation from normal behavior. The WID system 700 may then aggregate these anomaly scores over time windows and compare the anomaly scores against predefined thresholds to determine the presence of an intrusion event. By employing adaptive thresholding mechanisms and incorporating feedback from network administrators, the WID system 700 can dynamically adjust its sensitivity to balance false alarm rates with anomaly detection accuracy. Through anomaly score aggregation and thresholding mechanisms, the WID system 700 may mitigate false alarms, minimizing disruptions to network operations and reducing the burden on the network administrators.

Although a specific embodiment for a WID system 700 suitable for carrying out the various steps, processes, methods, and operations described herein is discussed with respect to FIG. 7, any of a variety of systems and/or processes may be utilized in accordance with embodiments of the disclosure. For example, instead of the GAN, another neural network such as the Kolmogorov-Arnold Networks (KANs) can be utilized for detecting intrusion events based on deep learning. In further examples, Self-Organizing Maps (SOMs), RNNs including LSTMs or Gated Recurrent Units (GRUs), GNNs, capsule networks, Graph Convolutional Networks (GCNs), or the like can be utilized in the access point 702 and/or the network device 716 for detecting intrusion events based on deep learning. In still yet additional embodiments, the WID system 700 may perform direct anomaly detection without discrimination. The elements depicted in FIG. 7 may also be interchangeable with other elements of FIGS. 1-6 and FIGS. 8-12 as required to realize a particularly desired embodiment.

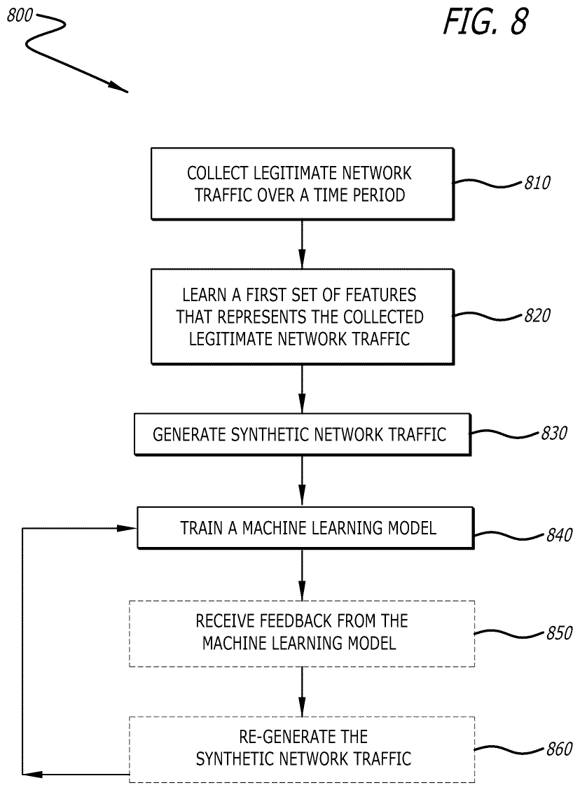

Referring to FIG. 8, a flowchart depicting a process 800 for training a machine learning model to classify network traffic for wireless intrusion detection in accordance with various embodiments of the disclosure is shown. In many embodiments, the process 800 may collect legitimate network traffic over a time period (block 810). The legitimate network traffic may refer to network traffic that may be authorized, expected, and typical for normal operations within a network. The network may include a wireless network, for example, a Wi-Fi® network. The legitimate network traffic may include, for example, packets of data from standard user activities, routine system processes, and communications that align with an intended use of the network. The time period may establish a baseline of normal behavior associated with the network, against which future deviations, for example, potential security threats, attacks, or anomalies, can be compared. Network traffic, being non-uniform, can fluctuate based on factors such as time of day, day of the week, seasonality, or external events. The time period may allow a first machine learning model to capture these variations and model a normal behavior state machine with network traffic patterns accordingly, thereby allowing normal behavior which may change slightly over time to be distinguished from anomalous behavior. For example, peak traffic hours or periodic network operations may occur at regular intervals, and the first machine learning model may need to be trained over a time period that includes these variations to understand the normal behavior for that environment. In a number of embodiments, the process 800 may collect the legitimate network traffic at a network device. In a variety of embodiments, the network device may correspond to an edge-based network device, for example, an access point, a switch, or a router. In various embodiments, the process 800 may utilize a sniffer implemented on the network device to collect the legitimate network traffic over the time period.

In more embodiments, the process 800 may learn a first set of features that represents the collected legitimate network traffic (block 820). The first set of features may include, for example, one or more of: header characteristics, payload characteristics, temporal characteristics, or state transition characteristics associated with the legitimate network traffic. The header characteristics may include information of a packet header, for example, a source address, a destination address, a protocol type, packet size, or the like. The payload characteristics may include expected application-specific data, for example, valid Uniform Resource Locators (URLs), payload content such as HyperText Markup Language (HTML), JavaScript Object Notation (JSON), extensible Markup Language (XML), content type, session data, or the like. The temporal characteristics may include, for example, traffic patterns such as burst patterns, idle times, session duration, frequency of legitimate requests, time-of-day patterns, or the like. The state transition characteristics may include, for example, state transitions for establishing a connection, login or authentication states, state transitions associated with session management, state transitions during protocol handshakes, data exchanges, or the like. In additional embodiments, the process 800 may configure the first machine learning model to learn the first set of features that represents the collected legitimate network traffic. The first machine learning model may, for example, be an ANN. In further embodiments, as the first machine learning model is trained, the first machine learning model may learn to map the first set of features to a set of internal states, where each state may represent a certain behavior or condition in the network. The states the first machine learning model may learn to recognize correspond to normal states of the behavior of the network, forming the normal behavior state machine.

In still more embodiments, the process 800 may generate synthetic network traffic (block 830). The synthetic network traffic may refer to artificially created or fake network traffic that mimics real-world or legitimate network traffic but is not sourced from actual network communications. The process 800 may generate the synthetic network traffic based on the learned first set of features. In still further embodiments, the process 800 may generate the synthetic network traffic based on another machine learning model, that is, a second machine learning model. The second machine learning model may be a neural network, for example, a generator of a GAN, configured to generate the synthetic network traffic. The process 800 may utilize the generator to receive random noise or latent variables from a noise database of the GAN and the learned first set of features as input and attempt to generate network traffic data or patterns that mimic real network traffic, specifically the normal behaviors learned from the normal behavior state machine. In still additional embodiments, the process 800 may generate the synthetic network traffic including a plurality of valid packets that mimics the legitimate network traffic. In some more embodiments, the process 800 may generate the synthetic network traffic including a plurality of invalid packets including one or more corrupted packets and one or more anomalous packets. In yet various embodiments, each packet of the plurality of invalid packets is different from the legitimate network traffic in terms of at least one of: a packet structure, one or more protocol specifications, header characteristics, payload characteristics, temporal characteristics, or state transition characteristics.

In yet more embodiments, the process 800 may train a machine learning model (block 840). The process 800 may train the machine learning model, that is, a third machine learning model, based on the learned first set of features and the generated synthetic network traffic. The third machine learning model may be different from the first machine learning model that learned the first set of features. Further, the third machine learning model may be different from the second machine learning model that generated the synthetic network traffic. The third machine learning model may be a neural network, for example, a discriminator of the GAN. Therefore, the second machine learning model and the third machine learning model correspond to the GAN. In still yet more embodiments, the second machine learning model and the third machine learning model may be deployed on the same network device as the first machine learning model. Based on the training, the third machine learning model may learn a second set of features that differentiates the generated synthetic network traffic from the collected legitimate network traffic. The second set of features may relate to aspects that differentiate the legitimate network traffic which may adhere to established patterns of normal behavior, from the synthetic network traffic which, even though mimics the legitimate network traffic, may have subtle inconsistencies. The second set of features may include, for example, patterns related to packet sizes, inter-arrival times, and traffic bursts, flow durations, protocol-specific features, inter-packet time, payload content, or the like. The process 800 may utilize the discriminator to differentiate between the collected legitimate network traffic and the synthetic network traffic generated by the generator. In an example, the discriminator may learn that real network traffic sessions tend to last a certain amount of time (e.g., a web browsing session lasting 30 seconds to a few minutes), whereas synthetic network traffic may have sessions that are either too short (e.g., no idle time) or overly uniform in length. In a further example, in a HyperText Transfer Protocol (HTTP), legitimate network traffic requests may often contain headers such as User-Agent, Host, Accept-Encoding, while the synthetic network traffic may generate requests with unrealistic or improbable combinations of headers. In a further example, the inter-arrival times between packets in the synthetic network traffic may be too uniform or too erratic compared to that of the legitimate network traffic, which may tend to have bursts followed by periods of inactivity.

In many further embodiments, the process 800 may optionally receive feedback from the machine learning model (block 850). The training phase of the GAN may rely on a large set of exchanges between the second machine learning model, that is, the generator, and the third machine learning model, that is, the discriminator. When such exchanges occur, the process 800 may rely on a feedback loop between the generator and the discriminator for improving efficiency of the GAN. At the discriminator, the process 800 may evaluate both the collected legitimate network traffic and the synthetic network traffic generated by the generator. The process 800, at the generator, may receive the feedback from the discriminator. In many additional embodiments, the feedback from the discriminator to the generator may include a probability, for example, between 0 and 1, indicating the likelihood that the input network traffic is legitimate (close to 1) or synthetic (close to 0).

In still yet further embodiments, the process 800 may optionally re-generate the synthetic network traffic (block 860) and proceed to train the machine learning model (block 840). On receiving the feedback from the discriminator, the process 800 may train the generator to minimize the ability of the discriminator to distinguish between the synthetic traffic data and the legitimate traffic data. The process 800, at the generator, may re-generate the synthetic network traffic based on the feedback received from the discriminator. The goal of the generator is to generate synthetic network traffic that gets classified as real by the discriminator. The process 800, at the generator, may therefore adjust its parameters to reduce the error in the discriminator's classification of its synthetic network traffic. Because one depends on the other, the generator may generate new samples based on the feedback that the previous samples were flagged by the discriminator as deviating from the established baseline, and the discriminator may flag deviations only based on the new samples generated by the generator. The process 800 may train the discriminator based on the synthetic network traffic re-generated by the generator.

As described above, the training phase of the GAN may rely on a large set of exchanges between the generator and the discriminator. When such exchanges occur, the developed model efficiency may rely on the feedback loop between the generator and discriminator. Because one depends on the other, the generator may generate new samples based on the feedback that the previous samples were flagged by the discriminator as deviating from the baseline, and the discriminator may flag deviations only based on the new samples generated by the generator. The GAN may have an ability to be particularly efficient in detecting some types of deviations, and a lower ability to detect some other types of deviations, which may correspond to a phenomenon called “convergence failure,” which may refer to statistical density differences in training deviations. To over-simplify the detection, because the detection is statistical and not field-specific, consider an example where the generator may generate some spoofing frames that the discriminator immediately identifies as such, causing the generator to stop generating more frames of that type; by contrast, the generator may generate some MitM frames that the discriminator does not identify well, causing the generator to continue producing more frames of that type until the discriminator produces a satisfactory output. In that over-simplified example, the GAN may be over-trained for MitM and undertrained for spoofing. In a lab setup where an arbitrary large number of frames may be injected into the GAN, the above mismatch in training (where, in the real world, would be statistical anomalies, not specific frame types) can easily be identified by detecting deviations that the GAN detects particularly well, and others where the GAN underperforms.

Although a specific embodiment for a process 800 for training a machine learning model to classify network traffic for wireless intrusion detection suitable for carrying out the various steps, processes, methods, and operations described herein is discussed with respect to FIG. 8, any of a variety of systems and/or processes may be utilized in accordance with embodiments of the disclosure. For example, the GAN may be trained on another network device different from the network device that constructs the normal behavior state machine. The elements depicted in FIG. 8 may also be interchangeable with other elements of FIGS. 1-7 and FIGS. 9-12 as required to realize a particularly desired embodiment.

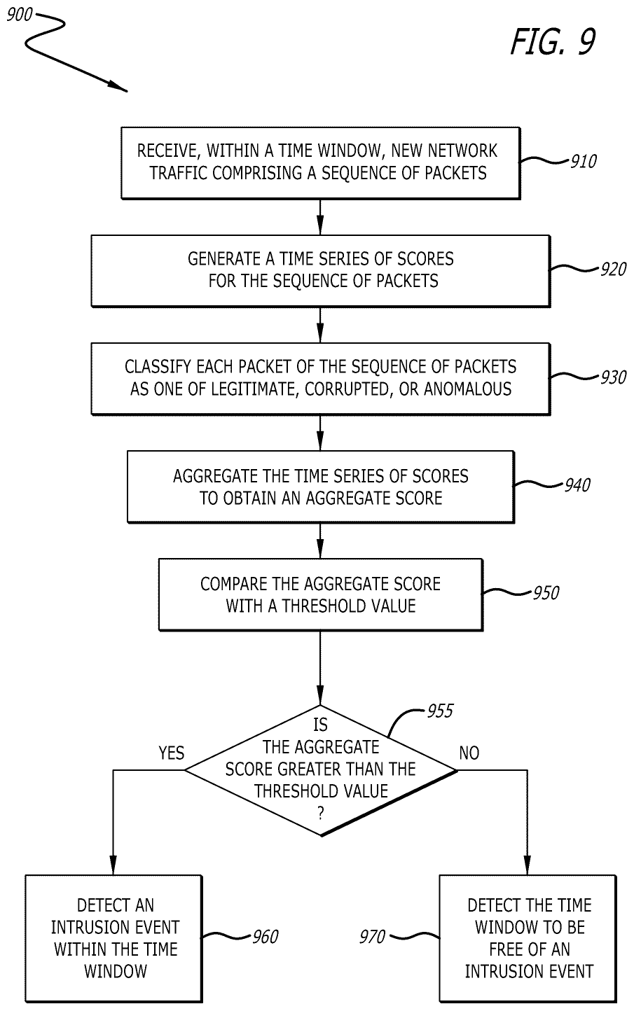

Referring to FIG. 9, a flowchart depicting a process 900 for detecting an intrusion event at an edge-based network device in accordance with various embodiments of the disclosure is shown. In many embodiments, the process 900 may receive, within a time window, new network traffic comprising a sequence of packets (block 910). The time window may refer to a time period during which network traffic is monitored, collected, and analyzed. The time window may refer to a temporal span during which the network traffic may be observed for detection of an intrusion event. The intrusion event may refer to any occurrence in a network, for example, a Wi-Fi network, where the network traffic or behavior does not align with normal states established by a normal behavior state machine, suggesting a potential security breach or network anomaly.

In a number of embodiments, the process 900 may generate a time series of scores for the sequence of packets (block 920). A time series of scores for the sequence of packets may refer to a series of values or metrics that are collected over time, where each value may represent an evaluation or an assessment of a packet or a group of packets at a specific point in time. The process 900 may generate the time series of scores for the sequence of packets based on a trained machine learning model. In a variety of embodiments, the trained machine learning model may refer to a discriminator of a GAN that is trained by utilizing a normal behavior state machine generated by a different machine learning model, for example, an ANN, and synthetic network traffic generated by a generator of the GAN. Each score in the time series of scores may correspond to a packet of the sequence of packets. Further, each score in the time series of scores may indicate a likelihood of the packet deviating from being legitimate. In various embodiments, each score in the time series of scores may correspond to a particular characteristic of the packets (e.g., whether the packet is part of a potential attack, its similarity to legitimate network traffic, or a performance metric such as delay or throughput). In more embodiments, each score in the time series of scores may refer to an anomaly score measuring how much a packet deviates from normal network traffic patterns. The anomaly score may indicate how likely the packet is to be anomalous. In additional embodiments, a high score may suggest that the packet is unusual, that is, corrupted or anomalous, compared to the normal network traffic patterns.

In further embodiments, the process 900 may classify each packet of the sequence of packets as one of legitimate, corrupted, or anomalous (block 930). The legitimate packet may refer to a packet of the received new network traffic that may be authorized, expected, and typical for normal operations within the network. Each legitimate packet may include, for example, a packet of data from standard user activities, routine system processes, and communications that align with an intended use of the network. Each legitimate packet may initiate from and/or may be destined for an authorized or uncompromised node of the network. Each legitimate packet may be non-malicious and may comply with established network policies. The corrupted packet may refer to a packet that has been altered, damaged, or otherwise degraded during transmission, typically due to errors or disruptions in the network. The anomalous packet may refer to a packet that may deviate from normal patterns, often indicating unusual or suspicious behavior. Each anomalous packet may include, for example, data associated with unexpected spikes in traffic, unusual data sources or destinations, or activities that may not align with typical user behavior. The process 900 may classify the packet as one of legitimate, corrupted, or anomalous based on a corresponding score in the time series of scores. In still more embodiments, the process 900 may utilize an ANN that constructs a normal behavior state machine and a GAN including the generator and a discriminator, for classifying each packet of the sequence of packets as one of legitimate, corrupted, or anomalous.

In still further embodiments, the process 900 may aggregate the time series of scores to obtain an aggregate score (block 940). The aggregate score may refer to a combined metric that summarizes the overall behavior of the sequence of packets within the time window. The aggregate score may consolidate the scores of individual packets into a single value that represents the behavior or characteristics of the entire network traffic flow or session. In still additional embodiments, the process 900 may obtain the aggregate score by summing the scores of the packets in the sequence. In some more embodiments, the process 900 may obtain the aggregate score by computing an arithmetic mean of the scores of the packets in the sequence. In yet various embodiments, the process 900 may obtain the aggregate score by assigning weights to different packets or score components and calculating a weighted average.

In yet more embodiments, the process 900 may compare the aggregate score with a threshold value (block 950). The process 900 may select the threshold value to distinguish between normal behavior and anomalous behavior in the network. In still yet more embodiments, the process 900 may select the threshold value based on historical data, expected network behavior, and the specific application to detect the intrusion event. In many further embodiments, the process 900 may select the threshold value by utilizing statistical methods, for example, empirical distribution, a z-score method, a chi-square test, or the like. In many additional embodiments, the process 900 may select the threshold value by utilizing machine learning-based methods, for example, probability scores, decision function values, or the like derived from decision boundaries, or a reconstruction error or distance from cluster centroids. In still yet further embodiments, where network traffic patterns change over time, the process 900 may select the threshold value based on an adaptive threshold. In these embodiments, the process 900 may continuously adjust the threshold value based on ongoing observations and learning from the normal behavior of the network. The process 900 may utilize techniques such as moving averages or exponential smoothing to update the threshold value in real time. In still yet additional embodiments, the process 900 may adjust the threshold value dynamically by utilizing a sliding window over recent aggregate scores, ensuring that the threshold value reflects a current behavior of the network for detecting anomalies. In several embodiments, a fixed threshold value may be utilized for the comparison.

In several more embodiments, the process 900 may determine whether the aggregate score is greater than the threshold value (block 955). The process 900 may compare the aggregate score with the threshold value for determining the intrusion event in the new network traffic within the time window. The aggregate score may represent a level of anomaly or normality in the network traffic. In numerous embodiments, the process 900 may compare the aggregate score with the threshold value to determine whether the aggregate score exceeds the threshold value. By way of a non-limiting example, while monitoring network traffic, the process 900 may compute an aggregate score by aggregating the time series of scores generated for the sequence of packets in the new network traffic. In numerous additional embodiments, the process 900 may generate the time series of scores based on how anomalous each packet is by utilizing factors such as unusual packet size, unexpected source IP addresses, irregular time intervals between packets, or other network traffic patterns. For example, the process 900 may generate the time series of scores as 10, 15, 80, 50, and 20 for a sequence of five packets P1, P2, P3, P4, and P5, respectively, where each packet's score may be determined based on an unusual or unexpected IP address, an irregular packet size, or an unusual network traffic pattern. In an example, P1's score of 10 may indicate PI may be close to normal, while P3's score of 80 may indicate P3 may be highly anomalous due to an unusual IP address or packet size. By utilizing, for example, an arithmetic mean, the process 900 may compute the aggregate score as 35. The process 900 may select the threshold value as 50 for performing a comparison and detecting an intrusion event.

In further additional embodiments, in response to determining that the aggregate score is greater than the threshold value, the process 900 may detect an intrusion event within the time window (block 960). The process 900 may detect an intrusion event within the time window based on a result of the comparison. The intrusion event may indicate an attack, for example, a DoS attack, unauthorized device access, or a malicious activity such as packet sniffing or data interception. The process 900 may utilize the threshold value to detect the intrusion event. The process 900 may detect the intrusion event within the time window based on the result indicating that the aggregate score is greater than the threshold value. In the above example, if the process 900 determines that the aggregate score is greater than the selected threshold value of 50, the process 900 may flag the network traffic as anomalous, potentially indicating an intrusion attempt or unusual behavior.

However, in many embodiments, in response to determining that the aggregate score is not greater than the threshold value, the process 900 may detect the time window to be free of an intrusion event (block 970). In the above example, the process 900 may determine that the aggregate score of 35 is not greater than the selected threshold value of 50 and therefore may determine the network traffic to be free of an intrusion event in the time window. Further, the process 900 may evaluate individual scores of the packets to determine whether the time window is completely free of the intrusion event. In the above example, the process 900 may further investigate P3 as P3 has a score of 80.

Although a specific embodiment for a process 900 for detecting an intrusion event at an edge-based network device suitable for carrying out the various steps, processes, methods, and operations described herein is discussed with respect to FIG. 9, any of a variety of systems and/or processes may be utilized in accordance with embodiments of the disclosure. For example, the threshold value can be a complementary threshold value from what is described above. In such a scenario, the intrusion event may be detected within the time window based on the result indicating that the aggregate score is less than the threshold value. The elements depicted in FIG. 9 may also be interchangeable with other elements of FIGS. 1-8 and FIGS. 10-12 as required to realize a particularly desired embodiment.

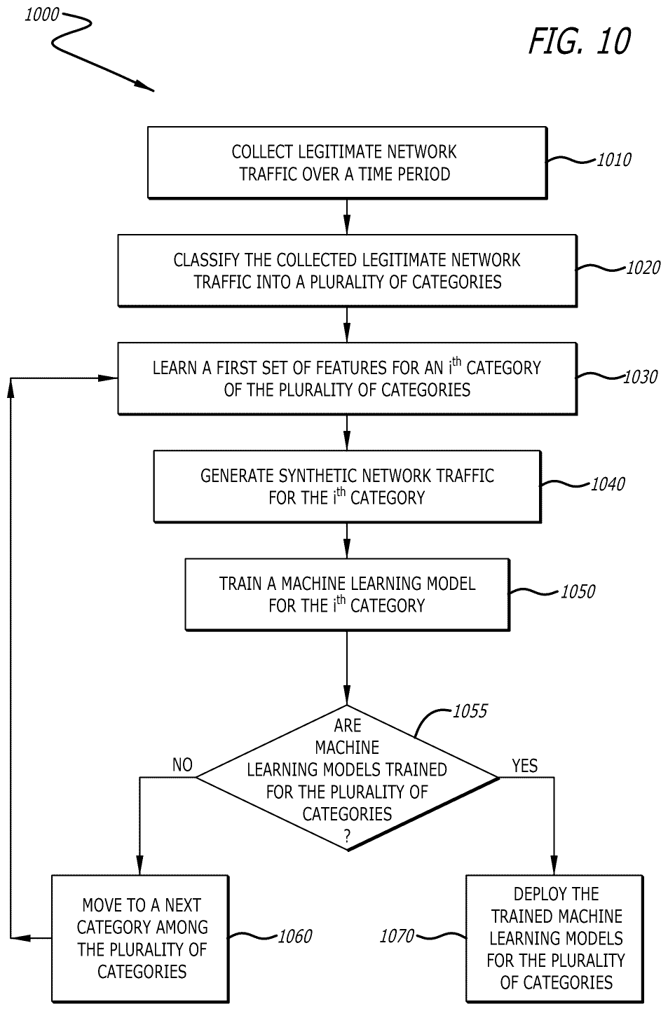

Referring to FIG. 10, a flowchart depicting a process 1000 for training statewise models for wireless intrusion detection in accordance with various embodiments of the disclosure is shown. In many embodiments, the process 1000 may collect legitimate network traffic over a time period (block 1010). The legitimate network traffic may refer to network traffic that may be authorized, expected, and typical for normal operations within a network. The network may include a wireless network, for example, a Wi-Fi® network. The legitimate network traffic may include, for example, packets of data from standard user activities, routine system processes, and communications that align with an intended use of the network. The time period may establish a baseline of normal behavior associated with the network, against which future deviations, for example, potential security threats, attacks, or anomalies, can be compared. Network traffic, being non-uniform, can fluctuate based on factors such as time of day, day of the week, seasonality, or external events. The time period may allow a first machine learning model to capture these variations and model a normal behavior state machine with network traffic patterns accordingly, thereby allowing normal behavior which may change slightly over time to be distinguished from anomalous behavior. In a number of embodiments, the process 1000 may collect the legitimate network traffic at a network device. In a variety of embodiments, the network device may correspond to an edge-based network device, for example, an access point, a switch, or a router. In various embodiments, the process 1000 may utilize a sniffer implemented on the network device to collect the legitimate network traffic over the time period.

In more embodiments, the process 1000 may classify the collected legitimate network traffic into a plurality of categories (block 1020). The process 1000 may classify the collected legitimate network traffic into the plurality of categories based on one or more criteria. In additional embodiments, the criteria may include at least one of a packet type or a connection state. In further embodiments, the packet type may include at least one of: a management frame, a control frame, or a data frame. The management frame may refer to a frame utilized to establish, maintain, and terminate communication between devices in a wireless network. The management frame may handle the setup and management of a wireless connection between a client device such as a smartphone or a laptop, and a network device such as an access point. The management frame may be responsible for tasks such as authentication, association, and synchronization of the devices. The control frame may refer to a frame configured to support a reliable delivery of data in the wireless network by managing the flow of data and ensuring that frames are delivered correctly. The control frame may include, for example, a Request To Send (RTS), a Clear To Send (CTS), an acknowledgement, or the like. The data frame may refer to a frame configured to carry the actual user data across the wireless network. The data frame may encapsulate a payload including information being transmitted from one device to another, such as files, images, web pages, application-specific data, or the like.

The connection state may refer to a state the client device undergoes while connecting to the network device and exchanging data. Connection states may define a lifecycle of a wireless connection, from discovering available networks to exchanging data. In still more embodiments, the connection state may include at least one of: scanning, pre-authentication, authentication, association, or data exchange. The scanning state may refer to a state where the client device searches for available wireless networks, for example, Wi-Fi networks, to which to connect. In the scanning state, the client device may listen for beacon frames or actively probe to discover nearby network devices, for example, access points and their corresponding network details. The pre-authentication state may refer to a state where the client device and the network device exchange initial authentication information before an actual connection is established. The authentication state may refer to a state where the client device proves its identity to the network device before the client device is allowed to join the network. The association state may refer to a state where the client device, after a successful authentication with the network device, establishes a logical connection with the network device, allowing the device to transmit and receive data. The data exchange state may refer to a state where the client device that is authenticated and associated with the network device, initiates transmission and reception of actual user data. The data exchange state may represent an active phase of communication, where the client device can transmit application data, for example, web browsing data, file downloads, or streaming data. Based on the classification, each category of the plurality of categories may include a corresponding subset of packets of the plurality of packets. In still further embodiments, the process 1000 may employ machine learning techniques, for example, supervised learning techniques, unsupervised learning techniques, deep learning techniques, reinforcement learning, or the like to classify the collected legitimate network traffic into the plurality of categories. The classification of the collected legitimate network traffic into the plurality of categories may allow the WID system to focus on different aspects and parts of the network traffic for optimal detection of intrusions.

In still additional embodiments, the process 1000 may learn a first set of features for an i^{th} category of the plurality of categories (block 1030). The process 1000 may learn the first set of features for the i^{th} category based on the corresponding subset of packets. For example, if the process 1000 classifies the collected legitimate network traffic into three categories associated with three packet types, “i” may include 1, 2, and 3, where the first category may be associated with the control frame, the second category may be associated with the management frame, and the third category may be associated with the data frame. The first set of features may include, for example, one or more of: header characteristics, payload characteristics, temporal characteristics, or state transition characteristics associated with the legitimate network traffic of the i^{th} category. The header characteristics may include information of a packet header, for example, a source address, a destination address, a protocol type, packet size, or the like. The payload characteristics may include expected application-specific data, for example, valid URLs, payload content such as HTML, JSON, XML, content type, session data, or the like. The temporal characteristics may include, for example, traffic patterns such as burst patterns, idle times, session duration, frequency of legitimate requests, time-of-day patterns, or the like. The state transition characteristics may include, for example, state transitions for establishing a connection, login or authentication states, state transitions associated with session management, state transitions during protocol handshakes, data exchanges, or the like. In some more embodiments, the process 1000 may configure the first machine learning model to learn the first set of features for the i^{th} category of the collected legitimate network traffic. The first machine learning model may, for example, be an ANN. In yet various embodiments, as the first machine learning model is trained, the first machine learning model may learn to map the first set of features to a set of internal states, where each state may represent a certain behavior or condition in the network. The states the first machine learning model may learn to recognize correspond to normal states of the behavior of the network, forming the normal behavior state machine.

In yet more embodiments, the process 1000 may generate synthetic network traffic for the i^{th} category (block 1040). The synthetic network traffic may refer to artificially created or fake network traffic that mimics real-world or legitimate network traffic but is not sourced from actual network communications. The process 1000 may generate the synthetic network traffic based on the learned first set of features for the i^{th} category. In still yet more embodiments, the process 1000 may generate the synthetic network traffic for the i^{th} category based on another machine learning model, that is, a second machine learning model. The second machine learning model may be a neural network, for example, a generator of a GAN, configured to generate the synthetic network traffic. The process 1000 may utilize the generator to receive random noise or latent variables from a noise database of the GAN and the learned first set of features for the i^{th} category as input and attempt to generate network traffic data or patterns that mimic real network traffic, specifically the normal behaviors learned from the normal behavior state machine. In many further embodiments, the process 1000 may generate the synthetic network traffic including a plurality of valid packets that mimics the legitimate network traffic. In many additional embodiments, the process 1000 may generate the synthetic network traffic including a plurality of invalid packets including one or more corrupted packets and one or more anomalous packets. In still yet further embodiments, each packet of the plurality of invalid packets is different from the legitimate network traffic in terms of at least one of: a packet structure, one or more protocol specifications, header characteristics, payload characteristics, temporal characteristics, or state transition characteristics.

In still yet additional embodiments, the process 1000 may train a machine learning model for the i^{th} category (block 1050). The process 1000 may train the machine learning model, that is, a third machine learning model, for the i^{th} category based on the learned first set of features for the i^{th} category and the generated synthetic network traffic. The third machine learning model may be different from the first machine learning model that learned the first set of features. Further, the third machine learning model may be different from the second machine learning model that generated the synthetic network traffic. The third machine learning model may be a neural network, for example, a discriminator of the GAN. Therefore, the second machine learning model and the third machine learning model correspond to the GAN. In several embodiments, the second machine learning model and the third machine learning model may be deployed on the same network device as the first machine learning model. Based on the training, the third machine learning model may learn a second set of features that differentiates the generated synthetic network traffic from the collected legitimate network traffic associated with the i^{th} category. For example, the third machine learning model may learn the second set of features that differentiates the generated synthetic network traffic from the corresponding subset of packets associated with the i^{th} category. The second set of features may relate to aspects that differentiate the corresponding subset of packets which may adhere to established patterns of normal behavior, from the synthetic network traffic which, even though mimics the legitimate network traffic, may have subtle inconsistencies. The second set of features may include, for example, patterns related to packet sizes, inter-arrival times, and traffic bursts, flow durations, protocol-specific features, inter-packet time, payload content, or the like. The process 1000 may utilize the discriminator to differentiate between the collected legitimate network traffic and the synthetic network traffic generated by the generator.

In several more embodiments, the process 1000 may determine whether the machine learning models are trained for the plurality of categories (block 1055). The process 1000 may determine whether the machine learning models are trained for all the categories into which the collected legitimate network traffic is classified to ensure that each machine learning model has learned the second set of features that differentiates synthetic network traffic from the legitimate network traffic associated with the i^{th} category. If the machine learning models are not trained for all the categories, there may be a misclassification of the packets of new network traffic into legitimate network traffic, corrupted network traffic, and anomalous network traffic. Further, the misclassification may disallow intrusion events to be accurately detected. In numerous embodiments, the process 1000 may evaluate the machine learning models across all the categories to ensure that the machine learning models accurately classify the packets of the network traffic as legitimate, corrupted, or anomalous, and accordingly detect intrusion events therewithin.

In numerous additional embodiments, in response to determining that the machine learning models are not trained for the plurality of categories, the process 1000 may move to a next category among the plurality of categories (block 1060). The process 1000 may determine that the machine learning models are not trained for each category based on the evaluation across each category. The process 1000 may proceed to learn the first set of features for the next category of the plurality of categories (block 1030) and repeat the training process for the next category. The process 1000 may iteratively repeat the training process until the machine learning models are trained for all the categories.

In further additional embodiments, in response to determining that the machine learning models are trained for the plurality of categories, the process 1000 may deploy the trained machine learning models for the plurality of categories (block 1070). In many embodiments, the process 1000 may deploy the trained machine learning models for the plurality of categories on a WID system implemented on a single network device. In a number of embodiments, the process 1000 may deploy the trained machine learning models for the plurality of categories on at least two network devices of the WID system. The machine learning models that are trained for the plurality of categories based on the connection states may be herein referred to as “statewise models.” After deployment of the statewise models for the plurality of categories, the WID system may proceed to monitor and analyze wireless network traffic, for example, Wi-Fi network traffic, to identify threats such as malware, system vulnerabilities, or the like, and attacks such as unauthorized access, data breaches, DOS attacks, ransomware attacks, damage, or other malicious activities and intrusions. The statewise models can track the different connection states, for example, scanning, authentication, association, data exchange, or the like. In a variety of embodiments, the statewise models may represent multiple versions of the GAN for different connection states. Based on the current state of the connection, the WID system can classify new network traffic as either legitimate network traffic, corrupted network traffic, or anomalous network traffic.

Although a specific embodiment for a process 1000 for training statewise models for wireless intrusion detection suitable for carrying out the various steps, processes, methods, and operations described herein is discussed with respect to FIG. 10 any of a variety of systems and/or processes may be utilized in accordance with embodiments of the disclosure. For example, in still yet additional embodiments, in addition to packet type and connection state, other criteria such as flow characteristics including flow duration, flow size, flow rate, or the like, packet inter-arrival times, IP addresses, geographic location, port numbers, protocols, etc., may be utilized to classify the legitimate network traffic into the plurality of categories. The elements depicted in FIG. 10 may also be interchangeable with other elements of FIGS. 1-9 and FIGS. 11-12 as required to realize a particularly desired embodiment.

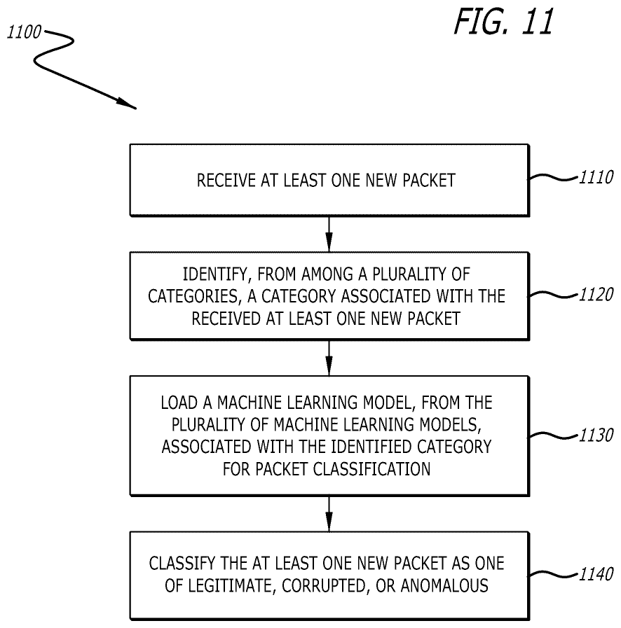

Referring to FIG. 11, a flowchart depicting a process 1100 for deploying statewise models for wireless intrusion detection in accordance with various embodiments of the disclosure is shown. In many embodiments, the process 1100 may receive at least one new packet (block 1110). The new packet may include, for example, a control frame, a management frame, or a data frame. The process 1100 may receive the new packet at a network device. In a number of embodiments, the network device may correspond to an edge-based network device, for example, an access point, a switch, or a router. In a variety of embodiments, the process 1100 may utilize a sniffer to receive the new packet at the network device.

In various embodiments, the process 1100 may identify, from among a plurality of categories, a category associated with the received at least one new packet (block 1120). The process 1100 may identify the category associated with the new packet by analyzing various characteristics of the new packet. In more embodiments, the process 1100 may inspect a protocol utilized in the communication and other header fields that define the structure of the new packet. In an example, the process 1100 may identify a control frame by inspecting a header of the new packet for a protocol type such as ICMP, ARP, or the like. In a further example, the process 1100 may identify a management frame by inspecting a frame control field in the header of the new packet, which may specify the type of frame such as association, authentication, beacon, or the like. In a further example, the process 1100 may identify a data frame by examining a transport layer protocol, for example, TCP or UDP, in the header of the new packet.

In additional embodiments, the process 1100 may load a machine learning model, from the plurality of machine learning models, associated with the identified category for packet classification (block 1130). The process 1100 may store multiple machine learning models, also referred to as statewise models, in a database on the network device. The machine learning models are associated with a plurality of categories for packet classification. After identifying the category associated with the new packet, the process 1100 may select and retrieve the machine learning model associated with the identified category of the packet from the database. The process 1100 may load the machine learning model associated with the identified category on the network device to proceed with the classification of the packet as one of legitimate, corrupted, or anomalous, thereby allowing faster, near real-time analysis of the packets. The process 1100 may load the machine learning model similar to a TinyML implementation, where smaller machine learning models allow for parallel processing of different use cases.

In further embodiments, the process 1100 may classify the at least one new packet as one of legitimate, corrupted, or anomalous (block 1140). The process 1100 may classify the new packet as one of legitimate, corrupted, or anomalous based on the trained machine learning model corresponding to the identified category. The legitimate packet may refer to a packet that may be authorized, expected, and typical for normal operations within a network. Each legitimate packet may be non-malicious and may comply with established network policies. The corrupted packet may refer to a packet that has been altered, damaged, or otherwise degraded during transmission, typically due to errors or disruptions in the network. The anomalous packet may refer to a packet that may deviate from normal patterns, often indicating unusual or suspicious behavior. In still more embodiments, the process 1100 may utilize a combination of a trained ANN and a trained GAN as the machine learning model for classifying the new packet as one of legitimate, corrupted, or anomalous. In still further embodiments, the process 1100 may analyze Frame Check Sequence (FCS) validity, Media Access Control (MAC) address changes, and field inconsistencies in the packet to classify the new packet as one of legitimate, corrupted, or anomalous. The discriminator of the trained GAN can be utilized to determine whether the new packet matches a normal pattern learned by the trained ANN and the GAN. If the discriminator identifies the new packet as “fake” or abnormal, the discriminator may indicate that the behavior of the network deviates from a normal state. If the new packet matches the normal state, the discriminator may flag the new packet as normal. If the new packet deviates minimally from the normal state with respect to a threshold value due to alterations during transmission, the discriminator may flag the new packet as corrupted. If the new packet deviates substantially from the normal state with respect to a threshold value or violates expected state transitions, the discriminator may flag the new packet as anomalous.

Although a specific embodiment for a process 1100 for deploying statewise models for wireless intrusion detection suitable for carrying out the various steps, processes, methods, and operations described herein is discussed with respect to FIG. 11, any of a variety of systems and/or processes may be utilized in accordance with embodiments of the disclosure. For example, in still additional embodiments, the process 1100 can load multiple machine learning models in parallel, but only apply the appropriate machine learning model to the new packet based on its category. This approach allows for real-time processing without the overhead of loading and unloading machine learning models repeatedly. The elements depicted in FIG. 11 may also be interchangeable with other elements of FIGS. 1-10 and FIG. 12 as required to realize a particularly desired embodiment.

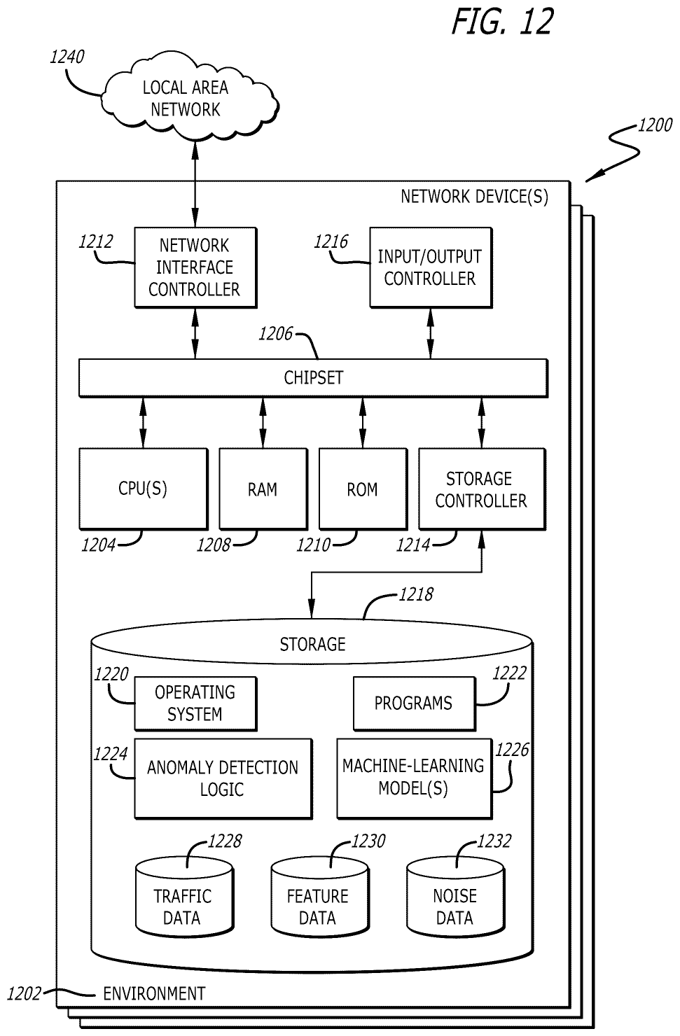

Referring to FIG. 12, a conceptual block diagram of a device 1200 suitable for configuration with the anomaly detection logic 1224 for implementing the functionality and various embodiments of the disclosure is shown. The embodiment of the device 1200 in the conceptual block diagram depicted in FIG. 12 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1200 may, in some examples, correspond to a physical device or to a virtual resource described herein. The device 1200 can be a network device, for example, an access point, a router, a switch, or any other edge-based network device in accordance with various embodiments of the disclosure.

In many embodiments, the device 1200 may include an environment 1202 such as a baseboard or a “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In a number of embodiments, one or more processors 1204, such as, but not limited to, central processing units (CPUs) can be configured to operate in conjunction with a chipset 1206. The processor(s) 1204 can be standard programmable CPUs that perform arithmetic and logical operations necessary for the operation of the device 1200.

In a variety of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a Random-Access Memory (RAM) 1208, which can be utilized as the main memory in the device 1200 in some embodiments. The chipset 1206 can further be configured to provide an interface to a computer-readable storage medium such as a Read-Only Memory (ROM) 1210 or a Non-Volatile RAM (NVRAM) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Different embodiments of the device 1200 can be configured to operate in a networked environment using logical connections to remote computing devices and computer systems through a network, such as the network 1240. The chipset 1206 can include functionality for providing network connectivity through a Network Interface Controller (NIC) 1212, which may include a gigabit Ethernet adapter or similar component. The NIC 1212 can be capable of connecting the device 1200 to other devices over the network 1240. It is contemplated that multiple NICs 1212 may be present in the device 1200, connecting the device 1200 to other types of networks and remote systems.

In more embodiments, the device 1200 can be connected to a storage 1218 that provides non-volatile storage for data accessible by the device 1200. The storage 1218 can, for example, store an operating system 1220, applications or programs 1222, network traffic data (denoted as “traffic data 1228” in FIG. 12), feature data 1230, and noise data 1232, which are described in greater detail below. The storage 1218 can be connected to the environment 1202 through a storage controller 1214 connected to the chipset 1206. In additional embodiments, the storage 1218 can include one or more physical storage units. The storage controller 1214 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1200 can store data within the storage 1218 by transforming the physical state of the physical storage units to reflect the information being stored. The specific transformation of the physical state can depend on various factors. Examples of such factors can include, but are not limited to, the technology utilized to implement the physical storage units, whether the storage 1218 is characterized as primary or secondary storage, and the like. For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to the device 1200. Stated otherwise, some or all of the operations performed by the cloud computing network, and or any components included therein, may be performed by the device 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1218 can store an operating system 1220 utilized to control the operation of the device 1200. According to one embodiment, the operating system 1220 includes the LINUX operating system. According to another embodiment, the operating system 1220 includes the Windows® server operating system from Microsoft Corporation of Redmond, Washington. According to further embodiments, the operating system 1220 can include the UNIX operating system or one of its variants. It should be appreciated that other operating systems can also be utilized. The storage 1218 can store other system or application programs and data utilized by the device 1200.

In still more embodiments, the storage 1218 or other computer-readable storage media is encoded with computer-executable instructions which, when loaded into the device 1200, may transform the device 1200 from a general-purpose computing system into a special-purpose computer capable of implementing the embodiments described herein. These computer-executable instructions may be stored as applications or programs 1222 and transform the device 1200 by specifying how the processor(s) 1204 can transition between states, as described above. In still further embodiments, the device 1200 has access to computer-readable storage media storing computer-executable instructions which, when executed by the device 1200, perform the various processes described above with regard to FIGS. 1-11. In still additional embodiments, the device 1200 can also include computer-readable storage media having instructions stored thereupon for performing any of the other computer-implemented operations described herein.

In some more embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 may not include all of the components shown in FIG. 12, and can include other components that are not explicitly shown in FIG. 12, or may utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In yet various embodiments, the device 1200 can include an anomaly detection logic 1224 that may be responsible for wireless intrusion detection based on deep learning. In yet more embodiments, the anomaly detection logic 1224 may operate in the edge-based network device. In embodiments where the device 1200 corresponds to the edge-based network device, for example, the access point, the anomaly detection logic 1224 can be configured to perform various operations such as, but not limited to, collecting legitimate network traffic over a time period; learning a first set of features that represents the collected legitimate network traffic; generating synthetic network traffic based on the learned first set of features; and training a machine learning model based on the learned first set of features and the generated synthetic network traffic, wherein based on the training, the machine learning model learns a second set of features that differentiates the generated synthetic network traffic from the collected legitimate network traffic. In still yet more embodiments where the device 1200 corresponds to the edge-based network device, the anomaly detection logic 1224 can be configured to perform various operations such as, but not limited to, collecting legitimate network traffic comprising a plurality of packets; classifying the collected legitimate network traffic into a plurality of categories based on one or more criteria, wherein based on the classification, each category of the plurality of categories comprises a corresponding subset of packets of the plurality of packets; for each category of the plurality of categories: learning a first set of features based on the corresponding subset of packets; generating synthetic network traffic based on the learned first set of features; and training a machine learning model based on the learned first set of features and the generated synthetic network traffic, wherein based on the training, the machine learning model learns a second set of features that differentiates the generated synthetic network traffic from the corresponding subset of packets.

Those skilled in the art will recognize that the anomaly detection logic 1224 can include various hardware and/or software deployments and can be configured in a variety of ways. In many additional embodiments, the anomaly detection logic 1224 can be configured as a standalone device, exist as a logic in another network device, be distributed among various network devices operating in tandem, or remotely operated as part of a cloud-based network management tool. In still yet further embodiments, one or more servers can be configured with the anomaly detection logic 1224 or can otherwise operate as the anomaly detection logic 1224. In still yet additional embodiments, the anomaly detection logic 1224 may operate on one or more servers connected to a communication network, for example, the Internet. The communication network can include wired networks or wireless networks. The anomaly detection logic 1224 can be provided as a cloud-based service that can service remote networks, such as, but not limited to, a deployed network. Further, in several embodiments, the anomaly detection logic 1224 may be operated as a distributed logic across multiple network devices. In an embodiment, the controller can operate as the anomaly detection logic 1224 or may have multiple devices operate as the anomaly detection logic 1224 in a distributed manner.

In several more embodiments, the storage 1218 can include network traffic data 1228. The network traffic data 1228 may relate to data representative of network traffic flows transmitted over a network. The network traffic data 1228 may include data associated with individual packets that constitute the network traffic. For example, the network traffic data 1228 may include files, messages, queries, system updates, requests, response, and associated data including timestamps indicating exact times when the packets were transmitted or received via a network, packet size indicating the type of application, a source address, a destination address, source ports, destination ports, protocol types, flags, packet count, or the like. In numerous embodiments, the network traffic data 1228 may include, for example, flow duration, number of packets per flow, bytes per flow, flow start and end times, session count, traffic volume, traffic rate, byte distribution, round-trip time, or the like. In numerous additional embodiments, the network traffic data 1228 may be preprocessed before being input to the machine learning model(s) 1226.

In further additional embodiments, the storage 1218 can include feature data 1230. The feature data 1230 may relate to data representative of the features representing the network traffic. The features may include, for example, header characteristics, payload characteristics, temporal characteristics, or state transition characteristics associated with the network traffic. The features may be mapped into different states that represent normal behaviors of the network during periods of normal operation for construction of a normal behavior state machine.

In many embodiments, the storage 1218 can include noise data 1232. The noise data 1232 may relate to data representative of noise fed into a generator of the GAN for facilitating generation of synthetic network traffic. For example, the noise data 1232 may include random noise or latent variables represented as a random input vector. In a number of embodiments, the noise data 1232 may be utilized by the anomaly detection logic 1224 to generate synthetic network traffic based on the features learned by another machine learning module.

In a variety of embodiments, data may be processed into a format usable by a machine learning (“ML”) model(s) 1226 (e.g., feature vectors), and/or other pre-processing techniques. The ML model(s) 1226 may be any type of ML model(s), such as supervised models, reinforcement models, and/or unsupervised models. The ML model(s) 1226 may include one or more of linear regression models, logistic regression models, decision trees, Naïve Bayes models, neural networks, k-means cluster models, random forest models, and/or other types of ML models. The ML model(s) may include an ANN and a GAN. In various embodiments, the ML model(s) 1226 may be configured to analyze the network traffic data 1228 for learning a first set of features that represents legitimate network traffic. In more embodiments, the ML model(s) 1226 may be configured to analyze the feature data 1230 and the noise data 1232 and generate synthetic network traffic. In additional embodiments, the ML model(s) 1226 may be configured to analyze the synthetic network traffic and the feature data 1230 to differentiate between the legitimate network traffic and synthetic network traffic. In further embodiments, the ML model(s) 1226 may be utilized to identify various parameters to include in the feature data 1230. For example, the ML model(s) 1226 may analyze the feature data 1230 and identify parameters that are required to augment the feature data 1230. Once the parameters are identified, the anomaly detection logic 1224 may utilize the parameters to perform wireless intrusion detection based on deep learning.

Although a specific embodiment for a device 1200 suitable for configuration with the anomaly detection logic 1224 for carrying out the various steps, processes, methods, and operations described herein is discussed with respect to FIG. 12, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the anomaly detection logic 1224 acts in tandem between the devices. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a network interface controller configured to provide access to a network; and
a memory communicatively coupled to the processor, wherein the memory comprises an anomaly detection logic configured to:
collect legitimate network traffic over a time period;
learn a first set of features that represents the collected legitimate network traffic;
generate synthetic network traffic based on the learned first set of features; and
train a machine learning model based on the learned first set of features and the generated synthetic network traffic, wherein based on the training, the machine learning model learns a second set of features that differentiates the generated synthetic network traffic from the collected legitimate network traffic.

2. The network device of claim 1, wherein the anomaly detection logic is further configured to:
receive, within a time window, new network traffic comprising a sequence of packets; and
generate, based on the trained machine learning model, a time series of scores for the sequence of packets, wherein each score in the time series of scores corresponds to a packet of the sequence of packets and indicates a likelihood of the packet deviating from being legitimate.

3. The network device of claim 2, wherein the anomaly detection logic is further configured to classify the packet as one of legitimate, corrupted, or anomalous based on a corresponding score in the time series of scores.

4. The network device of claim 3, wherein the anomaly detection logic is further configured to:
aggregate the time series of scores to obtain an aggregate score;
compare the aggregate score with a threshold value; and
detect an intrusion event within the time window based on a result of the comparison.

5. The network device of claim 4, wherein the intrusion event is detected within the time window based on the result indicating that the aggregate score is greater than the threshold value.

6. The network device of claim 4, wherein the intrusion event is detected within the time window based on the result indicating that the aggregate score is less than the threshold value.

7. The network device of claim 1, wherein the first set of features comprises one or more of: header characteristics, payload characteristics, temporal characteristics, or state transition characteristics associated with the legitimate network traffic.

8. The network device of claim 1, wherein the learning of the first set of features is based on another machine learning model different from the machine learning model.

9. The network device of claim 1, wherein the generation of the synthetic network traffic is based on another machine learning model, and the machine learning model and the another machine learning model correspond to a generative adversarial network.

10. The network device of claim 1, wherein during the training of the machine learning model, the anomaly detection logic is further configured to:
receive feedback from the machine learning model; and
re-generate the synthetic network traffic based on the feedback, wherein the machine learning model is further trained based on the re-generated synthetic network traffic.

11. The network device of claim 1, wherein the generation of the synthetic network traffic comprises generating a plurality of valid packets that mimics the legitimate network traffic.

12. The network device of claim 1, wherein the generation of the synthetic network traffic comprises generating a plurality of invalid packets including one or more corrupted packets and one or more anomalous packets.

13. The network device of claim 12, wherein each packet of the plurality of invalid packets is different from the legitimate network traffic in terms of at least one of: a packet structure, one or more protocol specifications, header characteristics, payload characteristics, temporal characteristics, or state transition characteristics.

14. The network device of claim 1, wherein the network device corresponds to an edge-based network device.

15. The network device of claim 1, wherein the network device corresponds to one of an access point, a switch, or a router.

16. A network device, comprising:
a processor;
a network interface controller configured to provide access to a network; and
a memory communicatively coupled to the processor, wherein the memory comprises an anomaly detection logic configured to:
collect legitimate network traffic comprising a plurality of packets;
classify the collected legitimate network traffic into a plurality of categories based on one or more criteria, wherein based on the classification, each category of the plurality of categories comprises a corresponding subset of packets of the plurality of packets;
for each category of the plurality of categories:
learn a first set of features based on the corresponding subset of packets;
generate synthetic network traffic based on the learned first set of features; and
train a machine learning model based on the learned first set of features and the generated synthetic network traffic, wherein based on the training, the machine learning model learns a second set of features that differentiates the generated synthetic network traffic from the corresponding subset of packets.

17. The network device of claim 16, wherein the one or more criteria comprises at least one of a packet type or a connection state.

18. The network device of claim 17, wherein
the packet type comprises at least one of: a management frame, a control frame, or a data frame, and
the connection state comprises at least one of: scanning, pre-authentication, authentication, association, or data exchange.

19. The network device of claim 16, wherein the anomaly detection logic is further configured to:
receive at least one new packet;
identify, from among the plurality of categories, a category associated with the received at least one new packet; and
classify the at least one new packet as one of: legitimate, corrupted, or anomalous based on the trained machine learning model corresponding to the identified category.

20. A method, comprising:
at an edge-based network device:
collecting legitimate network traffic over a time period;
learning a first set of features that represents the collected legitimate network traffic;
generating synthetic network traffic based on the learned first set of features; and
training a machine learning model based on the learned first set of features and the generated synthetic network traffic, wherein based on the training, the machine learning model learns a second set of features that differentiates the generated synthetic network traffic from the collected legitimate network traffic.
